(19) United States
(12) Patent Application Publication
(10) Pub. No.: US 2021/0149034 A1
(43) Pub. Date: May 20, 2021

(54) OBJECT DETECTION APPARATUS, OBJECT DETECTION METHOD, AND COMPUTER-READABLE RECORDING MEDIUM

(71) Applicant: NEC Corporation, Minato-ku, Tokyo (JP)

(72) Inventor: Shingo YAMANOUCHI, Tokyo (JP)

(73) Assignee: NEC Corporation, Minato-ku, Tokyo (JP)

(21) Appl. No.: 16/628,117

(22) PCT Filed: Jul. 4, 2018
(86) PCT No.: PCT/JP2018/025416

§ 371 Date: Jan. 2, 2020

(30) Foreign Application Priority Data
Jul. 4, 2017 (JP) 2017-131542

(51) Int. Cl. G01S 13/04

(52) U.S. Cl. CPC G01S 13/04

(57) ABSTRACT

An object detection apparatus 1000 includes: a transmitting unit 1101 configured to emit, to an object 1003, radio waves that serve as transmission signals; a receiving unit 1102 configured to receive the reflected radio waves as reception signals; a spectrum calculation unit 1103 configured to calculate, based on the transmission signals and the reception signals, a spectrum in which a region of a position parameter and a region of a shape parameter of the object 1003 are taken as domains; and a parameter value calculation unit 1107 configured to calculate, based on the calculated spectrum, a value of the position parameter of the object 1003 and a value of the shape parameter thereof.

### TECHNICAL FIELD

The present invention relates to an object detection apparatus and an object detection method for detecting a target object based on radio waves reflected off the target object or radiated from the target object, and further relates to a computer-readable recording medium in which a program for realizing them is recorded.

### BACKGROUND ART

In contrast to light, radio waves (such as microwaves, millimeter waves, and terahertz waves) are superior in terms of ability to penetrate through objects. Imaging devices (object detection apparatuses) that use this penetrating ability of radio waves to image items behind clothes, items in bags, or the like, and perform inspection have been put to practical use.

Some methods have been proposed as the imaging method of object detection apparatuses. One of the methods is the array antenna method (see Non-Patent Document 1, for example). Hereinafter, the array antenna method will be described with reference to FIGS. 27 to 29. FIG. 27 is a diagram showing an object detection apparatus using the conventional array antenna method. FIG. 28 is a diagram showing a configuration of a receiver shown in FIG. 27.

As shown in FIG. 27, in the array antenna method, the object detection apparatus is provided with a transmitter 211 and a receiver 201. Furthermore, the transmitter 211 is provided with a transmitting antenna 212. The receiver 201 is provided with receiving antennas 201₁, 202₂, . . . , 202_{N} (where N is the number of receiving antennas).

The transmitter 211 emits, from the transmitting antenna 212, RF signals (radio waves) 213 to detection target objects 204₁, 204₂, . . . , 204_{K} (where K is the number of target objects). The RF signals (radio waves) 213 are reflected off the detection target objects 204₁, 204₂, . . . , 204_{K}, and reflected waves 203₁, 203₂, . . . , 203_{K} are respectively generated.

The generated reflected waves 203₁, 203₂, . . . , 203_{K} are received by the receiving antennas 201₁, 202₂, . . . , 202_{N}. The receiver 201 calculates, based on the received reflected waves 203₁, 203₂, . . . , 203_{K}, the radio wave strengths of the radio waves reflected off the detection target objects 204₁, 204₂, . . . , 204_{K}. Then, the receiver 201 images distributions of the calculated radio wave strengths. Accordingly, respective images of the detection target objects 204₁, 204₂, . . . , 204_{K} are obtained.

Furthermore, as shown in FIG. 28, when the array antenna method is used, the receiver 201 is provided with N receiving antennas 202₁, 202₂, . . . , 202_{N}. Also, the receiving antennas 202₁, 202₂, . . . , 202_{N} are assumed to be set at positions at respective distances d₁, d₂, . . . , d_{N} from a reference point 209. The reference point 209 is used for convenience to indicate the positions of the receiving antennas 202₁, 202₂, . . . , 202_{N}, and thus the position of the reference point 209 is set arbitrarily. In the receiver 201 shown in FIG. 28, the receiving antennas 202₁, 202₂, . . . , 202_{N} respectively receive K incoming waves 203₁, 203₂, . . . , 203_{K} of angles θₖ (k=1, 2, . . . K).

Here, it is assumed that the incoming waves 203₁, 203₂, . . . , 203_{K} respectively have complex amplitudes of [s(θ₁), s(θ₂), . . . , s(θ_{K})]. Because the receiver 201 is provided with a down-converter (not shown in FIG. 28), complex amplitudes (baseband signals) [r(d₁), r(d₂), . . . , r(d_{N})] of the RF signals received by the receiving antennas 202₁, 202₂, . . . , 202_{N} are extracted by this down-converter. Furthermore, the complex amplitudes [r(d₁), r(d₂), . . . , r(d_{N})] of the signals received by the receiving antennas 202₁, 202₂, . . . , 202_{N} are output to a signal processing unit 205.

In the receiving antennas 202₁, 202₂, . . . , 202_{N}, the relationship between the corresponding complex amplitudes [r(d₁), r(d₂), . . . , r(d_{N})] of the received signal and the corresponding complex amplitudes [s(θ₁), s(θ₂), . . . , s(θ_{K})] of the incoming wave is given by Formula (1) below.

$$\begin{matrix}[ Formula 1 ] & \\ \begin{matrix}r = As + n ( t ) , & \\ r ≡ {[ r ( {d}_{1} ) , r ( {d}_{2} ) , … , r ( {d}_{N} ) ]}^{T} , & \\ s ≡ {[ s ( {θ}_{1} ) , s ( {θ}_{2} ) , ⋯ , s ( {θ}_{K} ) ]}^{T} , & ( K \times one dimensional vector ) \\ A ≡ ( a ( {θ}_{1} ) , a ( {θ}_{2} ) , … , a ( {θ}_{K} ) ) , & ( N \times K - th dimensional matrix ) \\ a ( θ ) ≡ {[ h ( θ , {d}_{1} ) , h ( θ , {d}_{2} ) , … , h ( θ , {d}_{N} ) ]}^{T} , & \\ h ( θ , {d}_{n} ) ≡ exp ( - j \cdot 2 π \cdot {d}_{a} \cdot sin θ / λ ) , & \end{matrix} \} & ( 1 )\end{matrix}$$

In Formula (1) above, n(t) is a vector whose element is noise content. An additional character T denotes a transpose of a vector or a matrix. λ is a wavelength of the incoming waves (RF signals) 203₁, 203₂, . . . , 203_{K}.

Furthermore, in Formula (1) above, a complex amplitude r of a reception signal is an amount obtained through a measurement. A direction matrix A is an amount that can be defined (designated) in signal processing. A complex amplitude s of an incoming wave is unknown, and estimation of the incoming wave direction aims to determine the direction of an incoming wave s based on a reception signal r obtained through a measurement.

In an incoming wave direction estimation algorithm, a correlation matrix R is calculated based on the reception signal r obtained through a measurement, which is given by Formula (2) below.

[Formula 2]

R=E[r·r^{H}] (2)

In Formula (2) above, E[ ] denotes that an element in the parenthesis is subjected to temporal averaging processing, and the additional character H denotes a complex conjugate transpose. Then, based on the calculated correlation matrix R, any of the evaluation functions given by Formulae (3) to (5) below is calculated.

$$\begin{matrix} [ Formula 3 ] & \\ {P}_{BF} ( θ ) = \frac{{a}^{H} ( θ ) Ra ( θ )}{{a}^{H} ( θ ) a ( θ )} , & ( 3 ) \\ [ Formula 4 ] & \\ {P}_{CP} ( θ ) = \frac{1}{{a}^{H} ( θ ) {R}^{- 1} a ( θ )} , ( Evaluation function of Capon method ) & ( 4 ) \\ [ Formula 5 ] & \\ {P}_{MU} ( θ ) = \frac{{a}^{H} ( θ ) a ( θ )}{{a}^{H} ( θ ) {E}_{N} {E}_{N}^{H} a ( θ )} , {E}_{N} = [ {e}_{K + 1} , … , {e}_{N} ] , & ( 5 )\end{matrix}$$

In the MUSIC method, E_{N}=[e_{K+1}, . . . , e_{N}] is a matrix that is configured by N−(K+1) vectors whose characteristic numbers indicate electric power of a noise n(t), out of characteristic vectors of the correlation matrix R.

Furthermore, in the conventional antenna array shown in FIG. 28, the procedure for calculating the correlation matrix R based on the reception signals r, as well as the procedure for calculating the evaluation function of any of Formulae (3) to (5) are executed by the signal processing unit 205.

According to the theory described in Non-Patent Document 1, the evaluation functions given by Formulae (3) to (5) have the peaks at angles θ₁, θ₂, . . . , θ_{K} of the incoming waves. Accordingly, if an evaluation function is calculated and a peak thereof is referenced, the angle of the corresponding incoming wave can be obtained. Based on a distribution of the angles of the incoming waves that are obtained using the evaluation functions given by Formulae (3) to (5), the positions and the shape of target objects can be displayed as images.

Other examples of object detection apparatuses according to the conventional antenna array type are also disclosed in Patent Documents 1 to 3. Specifically, the object detection apparatuses disclosed in Patent Documents 1 and 2 use phase shifters respectively connected to N receiving antennas built in a receiver to control the directionality of receiving array antennas, which are constituted by the N receiving antennas.

Also, the object detection apparatuses disclosed in Patent Documents 1 and 2 change the directionality of the N beam-shaped receiving array antennas, and emit directional beams of the receiving array antennas to K detection target objects. Accordingly, the strengths of radio waves reflected off the respective detection target objects are calculated.

Furthermore, the object detection apparatus disclosed in Patent Document 3 uses the frequency dependence of N receiving array antennas to control the directionality of the N receiving array antennas. Furthermore, similar to the examples of Patent Documents 1 and 2, the object detection apparatus disclosed in Patent Document 3 also emits directional beams of the N receiving array antennas to K detection target objects, and calculates the strengths of radio waves reflected off the respective detection target objects.

Furthermore, an actual object detection apparatus includes, as shown in FIG. 29, an array of receiving antennas 202 of N receiving antennas arranged in the vertical direction by N receiving antennas arranged in the horizontal direction, in order to display a two-dimensional image. In this case, the total number of required antennas is N². FIG. 29 is a diagram showing a schematic configuration of receiving array antennas when the conventional array antenna method is employed.

Patent Documents 4 and 5 disclose examples of a radar, instead of an imaging device. The radars disclosed in Patent Documents 4 and 5 measure a distance from the radar to a target object (at a position in the front-back direction with respect to the radar) using Frequency Modulated Continuous Wave (FMCW) signals. These radars also measure orientation in which the target object is present, by combining high resolution incoming direction estimation using the MUSIC method with the method for electronically scanning a beam direction of radio waves using array antennas, or the method for mechanically scanning a beam direction of radio waves by mechanically moving a device. Note that, in this case, the orientation of the target object is expressed by an angle with respect to a reference line that passes through the radar.

### LIST OF PRIOR ART DOCUMENTS

### Patent Documents

Patent Document 1: Japanese Translation of PCT International Application Publication No. 2013-528788
Patent Document 2: Japanese Patent Laid-Open Publication No. 2015-014611
Patent Document 3: Japanese Patent No. 5080795
Patent Document 4: Japanese Patent Laid-Open Publication No. 2007-285912
Patent Document 5: Japanese Patent Laid-Open Publication No. 2005-37354

### Non Patent Document

Non-Patent Document 1: Nobuyoshi, KIKUMA, “Fundamentals of Array Antennas”, MWE2010 Digest, (2010)

### DISCLOSURE OF THE INVENTION

### Problems to be Solved by the Invention

Meanwhile, in the array antenna method, if attempts are made to accurately detect a target object, the number of required receiving antennas and the number of associated receivers will significantly increase, resulting in the problem that the cost, size, and weight of an object detection apparatus will increase.

The above-described problem will be specifically described. First, in a case of the array antenna method, an inter-antenna distance between the receiving antennas 201₁, 202₂, . . . , 202_{N} needs to be set to half or less of the wavelength λ of the reflected waves 203₁, 203₂, . . . , 203_{K} that are received by the receiver 201. For example, if the reflected waves 203₁, 203₂, . . . , 203_{K} are millimeter waves, the wavelength λ is about several millimeters, and thus the inter-antenna distance is not greater than several millimeters. Also, if this condition is not satisfied, a problem will occur in that, in a generated image, a virtual image appears at a position at which none of the detection target objects 204₁, 204₂, . . . , 204_{K} are present.

Furthermore, the resolution of the image depends on a directional beam width Δθ of the receiving array antennas (201₁, 202₂, . . . , 202_{N}). The directional beam width Δθ of the receiving array antennas (201₁, 202₂, . . . , 202_{N}) is given as Δθ˜λ/D. Here, D is an aperture size of the receiving array antennas (201₁, 202₂, . . . , 202_{N}), and corresponds to the distance between the receiving antennas 202₁ and 202_{N} provided at both ends. In other words, in order to achieve a resolution that can be practically used in imaging items behind clothes, items in bags, or the like, the aperture size D of the receiving array antennas (201₁, 202₂, . . . , 202_{N}) needs to be set to a value from several tens of centimeters to about several meters.

In view of the above-described two conditions, namely, the condition that the inter-antenna distance between N receiving antennas is set to half or less of the wavelength λ (several millimeters or less), and the condition that the distance between the receiving antennas provided at two ends needs to be about at least several tens of centimeters, the number N of antennas required for each column is about several hundred.

Furthermore, an actual object detection apparatus includes, as shown in FIG. 29, an array of receiving antennas 202 of N receiving antennas arranged in the vertical direction by N receiving antennas arranged in the horizontal direction, in order to display a two-dimensional image. In this case, the total number of required receiving antennas is N². Accordingly, in order to employ the array antenna method, the total number of required receiving antennas and associated receivers is about several tens of thousands.

Since large numbers of receiving antennas and receivers are required in this way, the array antenna method is significantly expensive in terms of cost as described above. Furthermore, each antenna is arranged in a square region with each side being several tens of centimeters to several meters, and thus the device is significantly large and heavy.

On the other hand, radars, which encompass the radars disclosed in Patent Documents 4 and 5, can be typically downsized relative to the imaging devices disclosed in Patent Documents 1 to 3. However, due to being downsized, the resolution of the radars is reduced relative to that of the imaging devices. Due to the reduced resolution, the radars cannot identify the shape of a target object but can only recognize the position of the target object.

Specifically, when the FMCW method disclosed in Patent Documents 4 and 5 is employed, the resolution can be given as c/(2BW), where c is the speed of light, and BW is a bandwidth of an RF signal. Accordingly, if the bandwidth BW is set to 2 GHz, the resolution is calculated as 7.5 cm. With this resolution, although the position of a target object that is several centimeters in size can be measured, the shape of the target object that is several centimeters in size is hard to identify.

In addition, in the radars disclosed in Patent Documents 4 and 5, particularly for on-board applications, the aperture size D is reduced to about several centimeters. Accordingly, the directional beam width Δθ˜λ/D increases, also leading to the problem that the resolution of measurement in an angle direction (incoming direction estimation) is reduced. This problem occurs in both cases where the beam direction of radio waves is electronically scanned by using a device including a plurality of transmitting/receiving units and antennas, such as an array antenna, and where the beam direction of radio waves is mechanically scanned by using a device including a single transmitting/receiving unit, and an antenna, such as a parabola antenna.

The problem of trade-off occurring between the aperture size D of the antennas and resolution in angular direction measurement (incoming direction estimation), as described in connection to the above-described Patent Documents 1 to 5 is due to employing a method in which the position and shape of a target object are expressed by variables of an angle or orientation.

Furthermore, in the mechanical scanning methods disclosed in Patent Documents 4 and 5, there are the problems that the scan rate is limited to a low rate since the radar device is moved mechanically, that the device is large since it requires a driving device for mechanically activating the radar device, that mechanical scanning involving wear-out of the mechanism thereby reducing the lifetime of the device and increasing the maintenance cost, and the like.

As described above, in the conventional object detection apparatus, if a desired resolution of a millimeter wave image is to be achieved, the cost, size, and weight of the device will be significantly increased. On the other hand, if an attempt is made to downsize the device, there is the problem that the resolution of a millimeter wave image will be reduced.

Therefore, the usages and chances in which an object detection apparatus can be actually used are restricted. Furthermore, depending on the employed method, the speed of inspection of a target object is also restricted. In view of the aforementioned circumstances, there is a demand for reducing the numbers of required antennas and receivers compared to those in a conventional case, and realizing image generation with high-speed scanning without the need to move a receiver.

An example object of the invention is to provide an object detection apparatus, an object detection method, and a program that can solve the aforementioned problems, and can improve the accuracy of detecting an object using radio waves, while suppressing increases in the device cost, size, and weight.

### Means for Solving the Problems

In order to achieve the above-described object, according to one aspect of the invention, an object detection apparatus for detecting an object using radio waves, including:

a transmitting unit for emitting, to the object, radio waves that serve as transmission signals;

a receiving unit for receiving the radio waves reflected off the object as reception signals;

a spectrum calculating unit for calculating, based on the transmission signals and the reception signals, a spectrum in which a region of a position parameter of the object and a region of a shape parameter of the object are taken as domains; and

a parameter value calculating unit for calculating, based on the spectrum calculated by the spectrum calculating unit, a value of the position parameter of the object and a value of the shape parameter of the object.

Furthermore, according to one aspect of the invention, an object detection method for detecting an object using a device that includes a transmitting unit for emitting, to the object, radio waves that serve as transmission signals, and a receiving unit for receiving the radio waves reflected off the object as reception signals, the method including:

(a) a step of calculating, based on the transmission signals and the reception signals, a spectrum in which a region of a position parameter of the object and a region of a shape parameter of the object are taken as domains; and

(b) a step of calculating, based on the spectrum calculated in the (a) step, a value of the position parameter of the object and a value of the shape parameter of the object.

Moreover, in order to achieve the above-described object, according to one aspect of the invention, a computer readable recording medium for use in an object detection apparatus that includes a transmitting unit for emitting, to an object, radio waves that serve as transmission signals, a receiving unit for receiving the radio waves reflected off the object as reception signals, and a processor, the computer readable recording medium including a program recorded thereon, the program including instructions that cause the processor to carry out:

(a) a step of calculating, based on the transmission signals and the reception signals, a spectrum in which a region of a position parameter of the object and a region of a shape parameter of the object are taken as domains; and

(b) a step of calculating, based on the spectrum calculated in the (a) step, a value of the position parameter of the object and a value of the shape parameter of the object.

### Advantageous Effects of the Invention

As described above, according to the invention, it is possible to improve the accuracy of detecting an object using radio waves, while suppressing increases in the device cost, size, and weight.

### BRIEF DESCRIPTION OF THE DRAWINGS

FIG. 1 is a block diagram illustrating a configuration of an object detection apparatus according to a first example embodiment of the invention.

FIG. 2 is a diagram specifically illustrating configurations of a transmitting unit and a receiving unit of the object detection apparatus according to the first example embodiment of the invention.

FIG. 3 is a diagram specifically illustrating other configurations of the transmitting unit and the receiving unit of the object detection apparatus according to the first example embodiment of the invention.

FIG. 4 is a diagram illustrating an example of a transmission signal emitted by the object detection apparatus according to the first example embodiment of the invention.

FIG. 5 is a diagram illustrating another example of the transmission signal emitted by the object detection apparatus according to the first example embodiment of the invention.

FIG. 6 is a flow diagram illustrating an operation made by the object detection apparatus according to the first example embodiment of the invention.

FIG. 7 is a diagram illustrating, when K target objects are arranged, a layout of the target objects and a transmitting/receiving device.

FIG. 8 is a diagram illustrating a distribution of the reflectance of the K target objects.

FIG. 9 is a diagram illustrating a relationship of parameter correspondence between a conventional antenna array method and the method according to the first example embodiment of the invention.

FIG. 10 is a diagram illustrating a state in which reflected waves from the target objects are correlated with each other.

FIG. 11 is a diagram illustrating an example of sub arrays that are configured by a plurality of virtual receiving antennas.

FIG. 12 is a graph of evaluation functions with the positions R and the widths Δ of the target objects taken as arguments.

FIG. 13 is a block diagram illustrating a configuration of an object detection apparatus according to a second example embodiment of the invention.

FIG. 14 is a flow diagram illustrating an operation made by the object detection apparatus according to the second example embodiment of the invention.

FIG. 15 is a diagram illustrating a method for scanning arguments of the evaluation functions.

FIG. 16 illustrates evaluation function graphs with the width Δ of a target object taken as an argument.

FIG. 17 is a block diagram illustrating a configuration of an object detection apparatus according to a third example embodiment of the invention.

FIG. 18 is a diagram schematically illustrating a configuration of an outer appearance of the object detection apparatus according to the third example embodiment of the invention.

FIG. 19 is a flow diagram invention illustrating an operation made by the object detection apparatus according to the third example embodiment.

FIG. 20 is a diagram illustrating, when a target object is T-shaped, a positional relationship between the T-shaped target object and a transmitting/receiving device.

FIG. 21 is a projection view obtained by projecting the target object shown in FIG. 20 onto an x-y plane along a z-axis direction.

FIG. 22 illustrates examples of calculation results of the reflectance of the target object calculated in step A26 shown in FIG. 19.

FIG. 23 illustrates examples of an image of the target object generated in the third example embodiment of the invention.

FIG. 24 is a block diagram illustrating a configuration of an object detection apparatus according to a fourth example embodiment of the invention.

FIG. 25 is a flow diagram illustrating an operation made by the object detection apparatus according to the fourth example embodiment of the invention.

FIG. 26 is a block diagram illustrating an example of a computer that realizes the object detection apparatuses according to the first to fourth example embodiments of the invention.

FIG. 27 is a diagram illustrating an object detection apparatus that employs the conventional array antenna method.

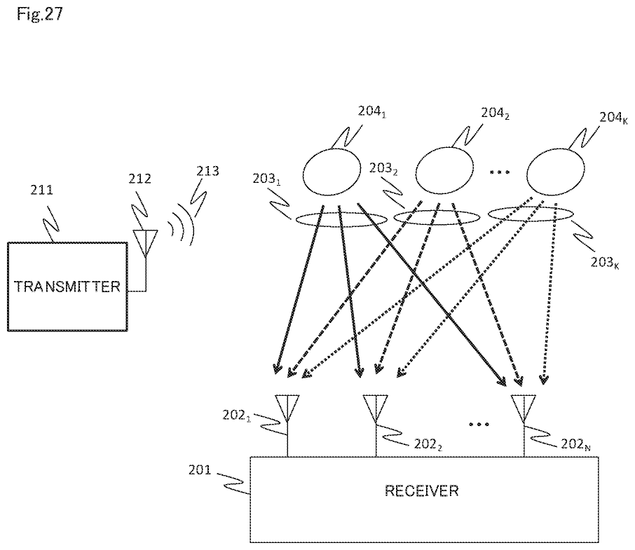

FIG. 28 is a diagram illustrating a configuration of a receiver that is shown in FIG. 27.

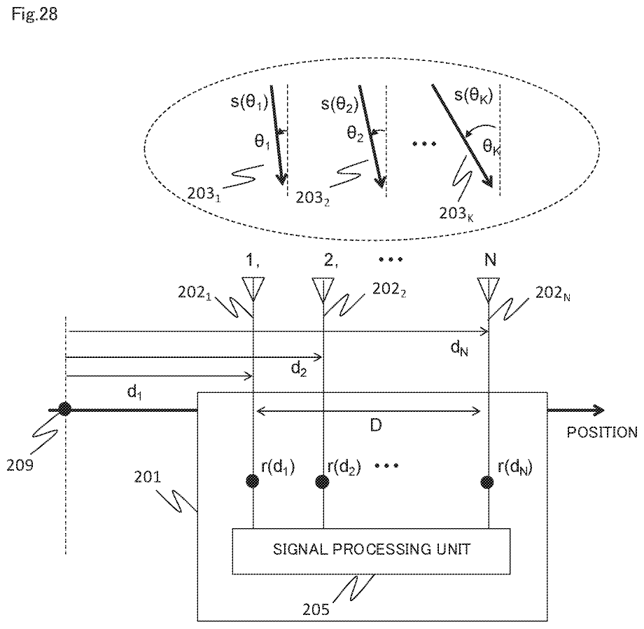

FIG. 29 is a diagram illustrating a schematic configuration of receiving array antennas when the conventional array antenna method is employed.

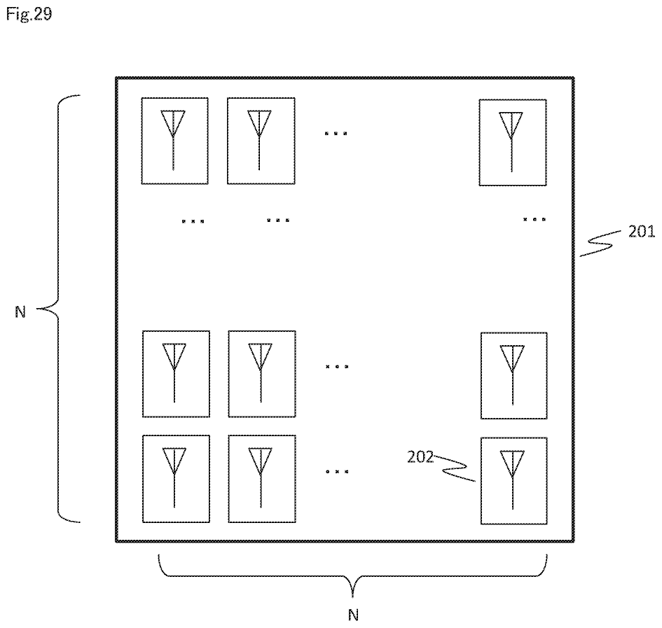

### MODE FOR CARRYING OUT THE INVENTION

### First Example Embodiment

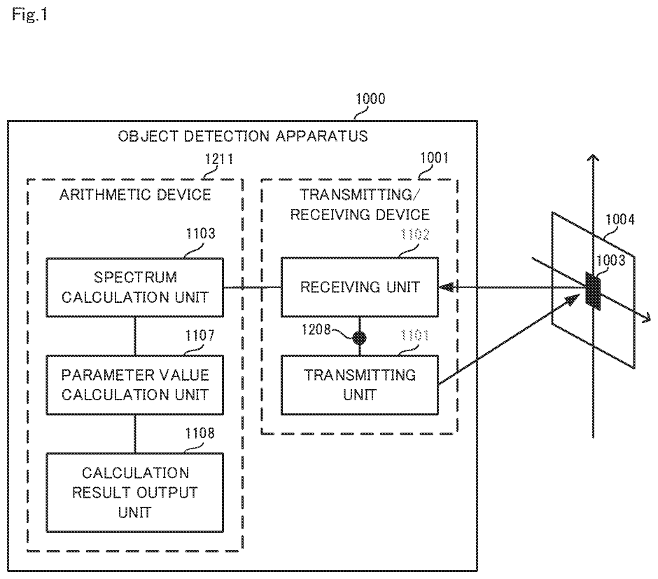

Hereinafter, an object detection apparatus, an object detection method, and a program according to a first example embodiment of the invention will be described with reference to FIGS. 1 to 12. The first example embodiment discloses an object detection apparatus, an object detection method, and a program that can not only recognize the position of a target object but also detect information relating to the shape, such as the width, of the target object, while using a small radar device.

[Apparatus Configuration]

First, a configuration of the object detection apparatus according to the first example embodiment will be described with reference to FIG. 1. FIG. 1 is a block diagram illustrating a configuration of the object detection apparatus according to the first example embodiment of the invention.

An object detection apparatus 1000 according to the present example embodiment shown in FIG. 1 is a device for detecting an object using radio waves. As shown in FIG. 1, the object detection apparatus 1000 is provided with a transmitting unit 1101, a receiving unit 1102, a spectrum calculation unit 1103, and a parameter value calculation unit 1107. Furthermore, in the first example embodiment, the object detection apparatus 1000 is also provided with a calculation result output unit 1108.

The transmitting unit 1101 emits, to an object 1003 to be detected (hereinafter, referred to as “target object”), radio waves that serve as transmission signals. The receiving unit 1102 receives the radio waves reflected off the target object 1003 as reception signals.

In the first example embodiment, the receiving unit 1102 further mixes the transmission signals generated by the transmitting unit 1101 with the received reception signals to generate intermediate frequency signals (hereinafter, referred to as “Intermediate Frequency (IF) signals”). Specifically, as shown in FIG. 1, the transmitting unit 1101 outputs the transmission signals to the receiving unit 1102 via a terminal 1208. The receiving unit 1102 mixes the transmission signals obtained via the terminal 1208 with the received radio waves reflected off the target object 1003, and outputs resultant IF signals.

Also, FIG. 1 shows one transmitting unit 1101 and one receiving unit 1102, but actually a plurality of transmitting units 1101 and a plurality of receiving units 1102 may also be provided. In the case where a plurality of transmitting units 1101 and a plurality of receiving units 1102 are provided, the receiving units 1102 are respectively associated with the transmitting units 1101.

The spectrum calculation unit 1103 calculates, based on the transmission signals and the reception signals, specifically, the IF signals, a spectrum in which a region of a parameter indicating the position of the target object 1003 (hereinafter, referred to as “position parameter”), and a region of a parameter indicating the shape of the target object 1003 (hereinafter, referred to as “shape parameter”) are taken as domains. The parameter value calculation unit 1107 calculates, based on the spectrum calculated by the spectrum calculation unit 1103, the value of the position parameter of the target object 1003, and the value of the shape parameter of the target object 1003.

The calculation result output unit 1108 outputs the values of the position parameter and the shape parameter of the target object 1003 that were calculated by the parameter value calculation unit 1107. Note that the format of output of the parameter values by the calculation result output unit 1108 is not particularly limited. A format of numerical value data, image data, and the like that is suitable for the system requirement is selected as the format of output.

In this way, in the first example embodiment, a spectrum in which a region of the position parameter of the target object 1003 and a region of the shape parameter thereof are taken as domains is calculated, and the values of the parameters indicating the position and the shape of the target object 1003 are calculated based on the spectrum. In other words, according to the first example embodiment, it is possible to calculate the value of the position parameter of the target object 1003 and the value of the shape parameter thereof, using a minimum configuration with a single transmitting unit 1101 and a single receiving unit 1102. Accordingly, in the first example embodiment, it is possible to improve the accuracy of detecting an object using radio waves, while suppressing increases in the device cost, size, and weight.

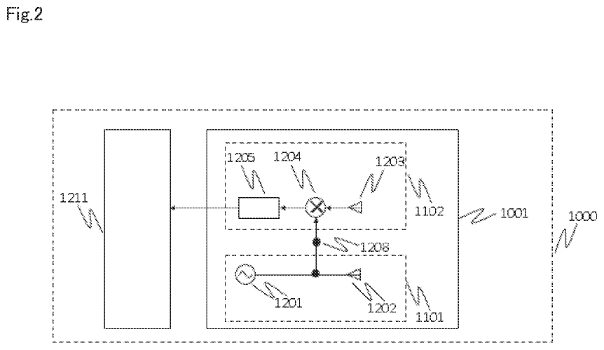

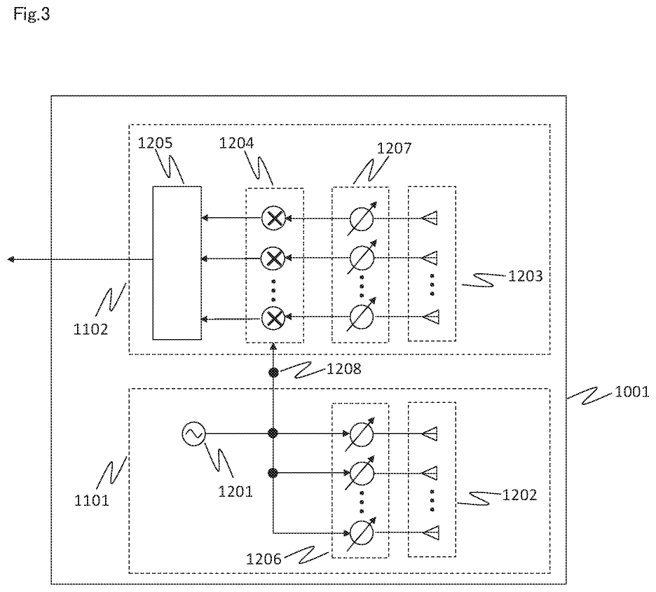

The following will more specifically describe a configuration of the object detection apparatus according to the first example embodiment with reference to FIGS. 2 and 3, in addition to FIG. 1. FIG. 2 is a diagram specifically illustrating configurations of the transmitting unit and the receiving unit of the object detection apparatus according to the first example embodiment of the invention. FIG. 3 is a diagram specifically illustrating other configurations of the transmitting unit and the receiving unit of the object detection apparatus according to the first example embodiment of the invention.

First, in the first example embodiment, as shown in FIGS. 1 and 2, the spectrum calculation unit 1103, the parameter value calculation unit 1107, and the calculation result output unit 1108 are configured by implementing a later-described program according to the first example embodiment into an arithmetic device (computer) 1211. Furthermore, in the first example embodiment, the transmitting unit 1101 and the receiving unit 1102 constitute a transmitting/receiving device 1001.

Furthermore, as shown in FIG. 2, in the first example embodiment, the transmitting unit 1101 of the transmitting/receiving device 1001 includes an oscillator 1201 and a transmitting antenna 1202. Furthermore, the receiving unit 1102 includes a receiving antenna 1203, a mixer 1204, and an interface circuit 1205. Furthermore, as described above, the transmitting unit 1101 and the receiving unit 1102 are connected to each other via the terminal 1208.

In the transmitting unit 1101, the oscillator 1201 generates an RF signal (radio wave). The RF signal generated by the oscillator 1201 is transmitted as a transmission signal from the transmitting antenna 1202, and is emitted to the target object 1003. The radio wave reflected off the target object 1003 is received by the receiving antenna 1203 of the receiving unit 1102.

The mixer 1204 mixes the RF signal input from the oscillator 1201 via the terminal 1208 with the radio wave (reception signal) received by the receiving antenna 1203 to generate an IF signal. The IF signal generated by the mixer 1204 is transmitted to the arithmetic device 1211 via the interface circuit 1205. The interface circuit 1205 functions to convert an IF signal, which is an analog signal, into a digital signal, which can be handled by the arithmetic device 1211, and outputs the obtained digital signal to the arithmetic device 1211.

Furthermore, in the example shown in FIG. 2, one transmitting/receiving device 1001 is provided with one transmitting antenna 1202 and one receiving antenna 1203, but the present example embodiment is not limited to this aspect. In the present example embodiment, for example, a configuration as shown in FIG. 3 is also possible in which one transmitting/receiving device 1001 is provided with a plurality of transmitting antennas 1202 and a plurality of receiving antennas 1203.

Specifically, in the example of FIG. 3, the transmitting unit 1101 is provided with one oscillator 1201 and a plurality of transmitting antennas 1202. The transmitting unit 1101 is further provided with variable phase shifters 1206 provided for the respective transmitting antennas 1202, and the transmitting antennas 1202 are connected to the oscillator 1201 via the variable phase shifters 1206. The variable phase shifters 1206 respectively control the phases of transmission signals to be supplied from the oscillator 1201 to the transmitting antennas 1202, thereby controlling the directionality of the transmitting antennas 1202.

Furthermore, in the example of FIG. 3, the receiving unit 1102 is provided with one interface circuit 1205 and a plurality of receiving antennas 1203. The receiving unit 1102 is further provided with mixers 1204 provided for the respective receiving antennas 1203, and variable phase shifters 1207 provided similarly for the respective receiving antennas 1203. The receiving antennas 1203 are connected to the interface circuit 1205 via the variable phase shifters 1207 and the mixers 1204.

The variable phase shifters 1207 respectively control the phases of reception signals that are supplied from the receiving antennas 1203 to the mixers 1204, thereby controlling the directionality of the receiving antennas 1203. Note that the variable phase shifters 1207 may also be arranged between the mixers 1204 and the interface circuit 1205.

Furthermore, the transmitting/receiving device 1001 shown in FIG. 2 has a preferable aspect in which it includes one transmitting antenna 1202 and one receiving antenna 1203, and the transmitting/receiving device 1001 shown in FIG. 3 has a preferable aspect in which it includes several transmitting antennas 1202 and several receiving antennas 1203. That is, in the first example embodiment, the object detection apparatus 1000 is preferably implemented as a device that is as small as an on-board radar.

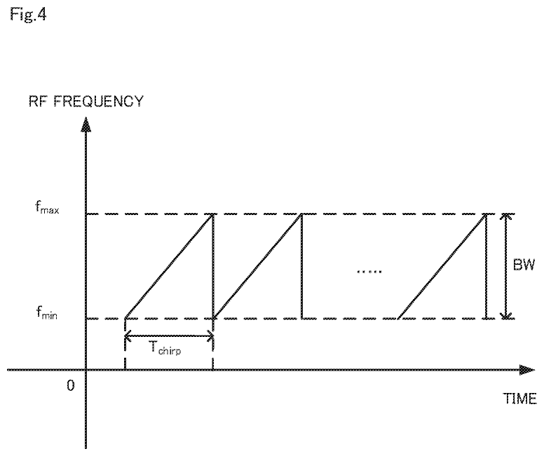

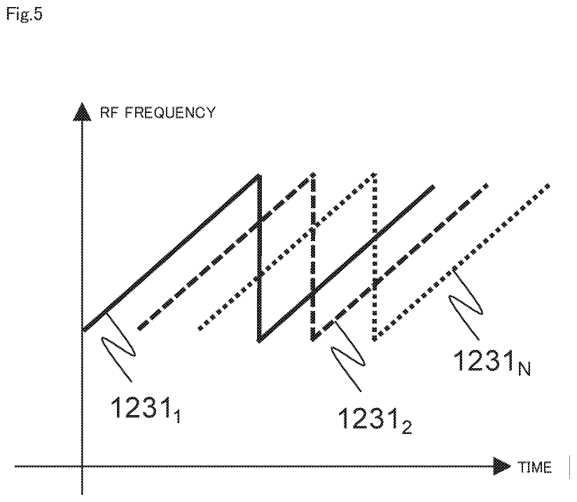

The following will describe a transmission signal that is emitted to an object in the present example embodiment, with reference to FIGS. 4 and 5. FIG. 4 is a diagram illustrating an example of a transmission signal that is emitted by the object detection apparatus according to the first example embodiment of the invention. FIG. 5 is a diagram illustrating another example of a transmission signal that is emitted by the object detection apparatus according to the first example embodiment of the invention.

First, in the first example embodiment, an RF signal that is generated by the oscillator 1201 is preferably an FMCW signal in which, as shown in FIG. 4, the RF frequency changes from fₘᵢₙ to fₘᵢₙ+BW with a period T_{chirp}. Note that fₘᵢₙ is the minimum value of the RF frequency, and BW is the bandwidth of the RF signal.

Furthermore, in the first example embodiment, if a plurality of transmitting/receiving devices 1001₁, 1001₂, . . . , 1001_{N} (where N is the number of transmitting/receiving devices 1001) are used, it is preferable that each of the transmitting/receiving devices 1001₁, 1001₂, . . . , 1001_{N} be controlled so as not to operate at the same time as another transmitting/receiving device, in order to avoid interference between the transmitting/receiving devices 1001₁, 1001₂, . . . , 1001_{N}. That is, the respective transmitting/receiving devices 1001₁, 1001₂, . . . , 1001_{N} are controlled so as to operate at timings different from each other, and the transmitting units 1101₁, 1101₂, . . . , 1101_{N} provided on the transmitting/receiving devices 1001₁, 1001₂, . . . , 1001_{N} emit radio waves at timings different from each other. By configuring the transmitting/receiving devices such that they do not operate at the same time, such a situation that the transmitting/receiving devices 1001₁, 1001₂, . . . , 1001_{N} interfere with each other can be avoided.

Furthermore, in the first example embodiment, if each of the transmitting/receiving devices 1001₁, 1001₂, . . . , 1001_{N} operates in the same time period as the time period in which another transmitting/receiving device operates, it is preferable that control be performed such that, as shown in FIG. 5, RF frequencies 1231₁, 1231₂, . . . , 1231_{N} of radio waves transmitted from the transmitting/receiving devices 1001₁, 1001₂, . . . , 1001_{N} do not have the same phase. With this, interference between the transmitting/receiving devices is suppressed.

[Apparatus Operation]

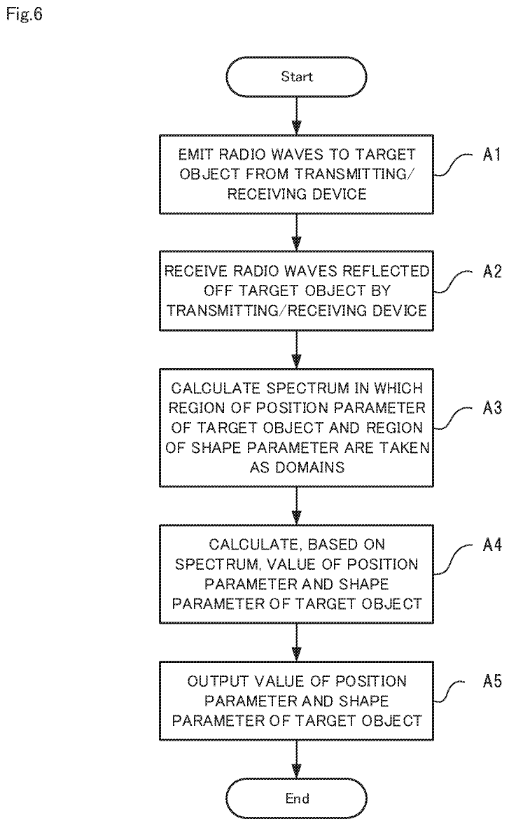

The following will describe an operation of the object detection apparatus 1000 according to the first example embodiment with reference to FIG. 6. FIG. 6 is a flow diagram illustrating an operation of the object detection apparatus according to the first example embodiment of the invention. In the following description, FIGS. 1 to 5 are referenced as needed. Furthermore, in the first example embodiment, an object detection method is executed by operating the object detection apparatus 1000. Accordingly, the description of the object detection method according to the first example embodiment is replaced by the following description of the operation of the object detection apparatus 1000.

As shown in FIG. 6, first, the transmitting unit 1101 of the transmitting/receiving device 1001 emits, to the target object 1003, radio waves that serve as transmission signals (step A1). Also, at the same time as the emission of radio waves serving as transmission signals, the transmitting unit 1101 outputs the transmission signals to the receiving unit 1102 via the terminal 1208.

Then, the receiving unit 1102 of the transmitting/receiving device 1001 receives the radio waves reflected off the target object 1003 as reception signals, and mixes the transmission signals generated by the transmitting unit 1101 with the received reception signals to generate IF signals (step A2).

Then, the spectrum calculation unit 1103 calculates, based on the IF signals generated in step A2, a spectrum (hereinafter, referred to as “target object spectrum”) in which a region of the position parameter of the target object 1003 and a region of the shape parameter thereof are taken as domains (step A3).

Then, the parameter value calculation unit 1107 calculates, based on the target object spectrum calculated in step A3, the value of the position parameter of the target object 1003 and the value of the shape parameter thereof (step A4).

Then, the calculation result output unit 1108 outputs the values of the position parameter and the shape parameter of the target object 1003 that were calculated by the parameter value calculation unit 1107 in step A4 (step A5).

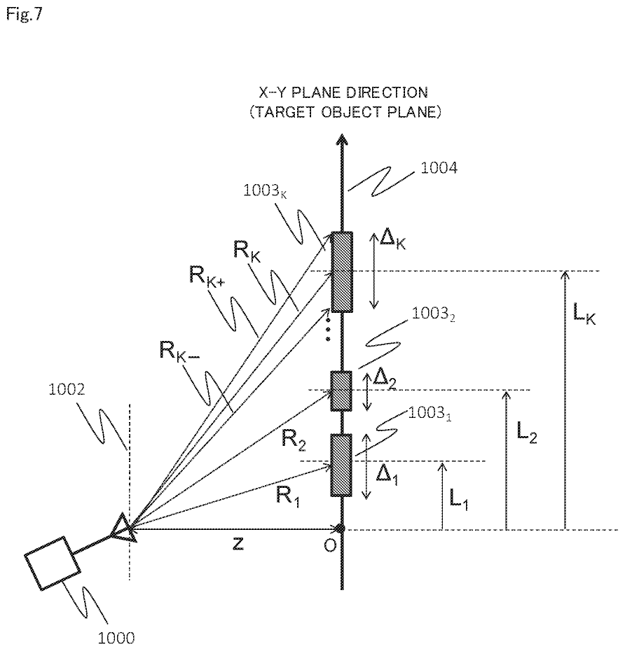

The following will describe steps A3 to A5 shown in FIG. 6 in more detail with reference to FIGS. 7 to 12.

[Step A3]

First, step A3 of calculating, based on the transmitted and received radio waves, a spectrum (target object spectrum) in which a region of the position parameter of the target object 1003 and a region of the shape parameter thereof are taken as domains will be described in detail.

In describing step A3, first, the positional relationship between a target object and a transmitting/receiving device will be described with reference to FIG. 7. FIG. 7 is a diagram illustrating, when K target objects are arranged, a layout of the target objects and a transmitting/receiving device.

First, a situation is taken as an example in which, as shown in FIG. 7, K target objects 1003₁, 1003₂, . . . , 1003_{K} are arranged at positions at which the distances from a transmitting/receiving device 1001 are R₁, R₂, . . . , R_{K}. Also, it is assumed that the target objects 1003₁, 1003₂, . . . , 1003_{K} respectively have widths Δ₁, Δ₂, . . . , Δ_{K} in a specific direction that intersects the radio waves emitted from the transmitting/receiving device 1001. The distances R₁, R₂, . . . , R_{K} and the widths Δ₁, Δ₂, . . . , Δ_{K} of the target objects are all unknown, and it is a task to measure the distances R₁, R₂, . . . , R_{K} and the widths Δ₁, Δ₂, . . . , Δ_{K} of the target objects. In the system shown in FIG. 7, a reception IF signal r(t) is given by Formula (6) below.

$$\begin{matrix}\begin{matrix}r ( t ) = {\sum }_{k = 1}^{K} {\int }_{{L}_{k} - {Δ}_{k} / 2}^{{L}_{k} + {Δ}_{k} / 2} dL σ ( L ) \frac{cos \vert 4 π ( {f}_{min} + {αt}^{′} ) \sqrt{{L}^{2} + {z}^{2}} / c \vert}{{L}^{2} + {z}^{2}} , \\ = {\sum }_{k = 1}^{K} {\int }_{{R}_{k -}}^{{R}_{k +}} dRσ ( R ) \frac{cos [ 4 π ( {f}_{min} + {αt}^{′} ) R / c ]}{R \sqrt{{R}^{2} - {z}^{2}}} , {t}^{′} = t - {hT}_{chirp} ,\end{matrix} & ( 6 ) \\ & \end{matrix}$$

In Formula (6), σ(R) is a reflectance of the target object that is present at the distance R. c is the speed of light, α is the time rate of change of an RF frequency, and α=BW/T_{chirp} is satisfied. T_{chirp} is a chirp period as shown in FIG. 4. t′ is a point in time within one chirp period, and takes a value from −T_{Chirp}/2 to T_{Chirp}/2. t′ is set to be from −T_{Chirp}/2 to T_{Chirp}/2, with consideration given to the periodicity of a chirp signal, by subtracting a chirp period (t′=t−hT_{Chirp}, where h is an integer) each time a chirp period has elapsed. As shown in FIG. 7, z is a distance between a transmitting/receiving device arranged plane 1002 and a target object arranged plane 1004. Also, Rₖ₊ denotes the distance between one end of the target object 1003k and the transmitting/receiving device 1001, and Rₖ₋ denotes the distance between the other end of the target object 1003ₖ and the transmitting/receiving device 1001. Based on the geometric relationship, Rₖ₊ and Rₖ₋ are given by Formula (7) below.

[Formula 7]

R_{k±}(uₖ)=\sqrt{Rₖ²+(Δₖ/2)²±LₖΔₖ}, (7)

Here, in Formula (7), uₖ is a two-dimensional variable that is a pair of distance Rₖ to the target object 1003ₖ and width Δₖ thereof, and is thus given by uₖ=(Rₖ, Δₖ) (k=1, 2, . . . , K). Furthermore, R_{k±}(uₖ) indicates that Rₖ₊ and Rₖ₋ are functions of uₖ=(Rₖ, Δₖ).

The reflectance σ(R) is assumed to take a finite constant value in a distance range from Rₖ₋ to Rₖ₊ in which the target object 1003ₖ (k=1, 2, . . . , K) is present. Also, the reflectance σ(R) is 0 (zero) in a distance range in which the target object 1003ₖ (k=1, 2, . . . , K) is not present.

Also, the reception IF signal r(t) given by Formula (6) above can be modified as indicated by Formula (8) below.

$$\begin{matrix}[ Formula 8 ] & \\ r ( t ) = {\sum }_{k = 1}^{K} σ ( {u}_{k} ) h ( {u}_{k} , t ) , \\ h ( {u}_{k} , t ) ≡ {\int }_{{R}_{k -} ( {u}_{k} )}^{{R}_{k +} ( {u}_{k} )} dR \frac{cos [ 4 π ( {f}_{min} + {αt}^{′} ) R / c ]}{R \sqrt{{R}^{2} - {z}^{2}}} , & ( 8 )\end{matrix}$$

In Formula (8) above, σ(uₖ) corresponds to a reflectance of the target object 1003ₖ. That is, σ(uₖ) is assumed to be equal to the value of the reflectance σ(R) in a distance range from Rₖ₋ to Rₖ₊ in which the target object 1003ₖ is present.

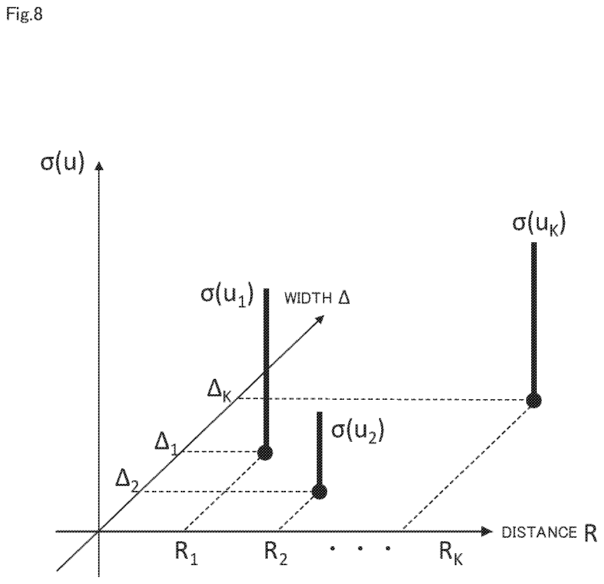

Here, the characteristics of the reflectance σ(u) with the two-dimensional variable u=(R, Δ), which is a pair of distance R and width Δ, taken as an argument, that is, as a domain is considered with reference to FIG. 8. FIG. 8 is a diagram illustrating a distribution of the reflectance of the K target objects.

As show in FIG. 8, the reflectance σ(u) is defined so as to have a nonzero value only at K two-dimensional positions uₖ=(Rₖ, Δₖ) (k=1, 2, . . . , K) that each correspond to the distance Rₖ and the width Δₖ of the target object 1003ₖ (k=1, 2, . . . , K), and so as to be zero at positions other than the above positions.

Here, if point coordinate values uₖ=(Rₖ, Δₖ) (k=1, 2, . . . , K) at which the reflectance σ(u) is nonzero can be obtained, the distance Rₖ and the width Δₖ of the target object 1003ₖ (k=1, 2, . . . , K) can be calculated based on the values of uₖ.

The following will describe a method for obtaining point coordinate values uₖ=(Rₖ, Δₖ) (k=1, 2, . . . , K) at which the reflectance σ(u) is nonzero.

The reception IF signal r(t) is assumed to be obtained at a sampling time tₘ (m=1, 2, . . . , M₀). M₀ is the number of times sampling is performed. It is assumed that the range of tₘ is a chirp period. A sampling time period Δt is given as T_{Chirp}/M₀, and tₘ=−T_{Chirp}/2+mΔt (m=1, 2, . . . , M₀) is obtained.

In view of above, Formula (8) can be rewritten into Formula (9) below. In Formula (9), n is a vector whose element is noise content.

$$\begin{matrix}[ Formula 9 ] & \\ \begin{matrix}r = As + n , & \\ r ≡ {[ r ( {t}_{1} ) , r ( {t}_{2} ) , … , r ( {t}_{M 0} ) ]}^{T} , & \\ s ≡ {[ σ ( {u}_{1} ) , σ ( {u}_{2} ) , ⋯ , σ ( {u}_{K} ) ]}^{T} , & \\ A ≡ ( a ( {u}_{1} ) , a ( {u}_{2} ) , … , a ( {u}_{K} ) ) , & \\ a ( u ) ≡ {[ h ( u , {t}_{1} ) , h ( u , {t}_{2} ) , … , h ( u , {t}_{M 0} ) ]}^{T} , & \\ h ( u , t ) ≡ {\int }_{{R}_{k -} ( u )}^{{R}_{k +} ( u )} dR \frac{cos [ 4 π ( {f}_{min} + {αt}_{m} ) R / c ]}{R \sqrt{{R}^{2} - {z}^{2}}} , & ( m = 1 , 2 , … , {M}_{0} )\end{matrix} \} & ( 9 )\end{matrix}$$

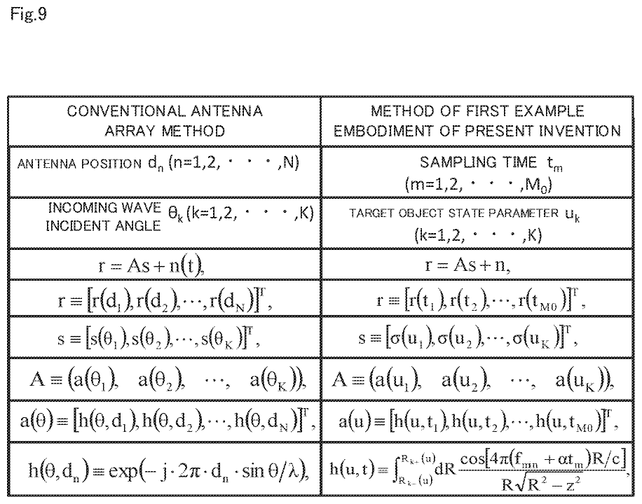

With reference to FIG. 9, Formula (9) indicating the operation according to the first example embodiment is compared with Formula (1) indicating an operation of a conventional antenna array method. FIG. 9 is a diagram illustrating a relationship of parameter correspondence between the conventional antenna array method and the method according to the first example embodiment of the invention.

As shown in FIG. 9, parameters of the conventional antenna array method correspond to parameters of the method according to the first example embodiment. Specifically, an antenna position dₙ (n=1, 2, . . . , N) and an incoming wave incident angle θₖ (k=1, 2, . . . , K) of the conventional antenna array method correspond to a sampling time tₘ (m=1, 2, . . . , M₀) and a target object state parameter uₖ (k=1, 2, . . . , K) of the first example embodiment. Note that the target object state parameter includes both the above-described position parameter and shape parameter.

Furthermore, in both the conventional antenna array method and the method according to the first example embodiment, the same r=As+n is satisfied. Accordingly, based on the evaluation function of the same form as that of the conventional antenna array method, a desired target object state parameter can be calculated also in the present example embodiment.

Specifically, in the conventional antenna array method, the value of the incoming wave incident angle θₖ (k=1, 2, . . . , K) is calculated based on the value of the argument 9 that gives the peak of an evaluation function given by one of Formulae (3) to (5). On the other hand, in the method according to the present example embodiment, the value of the target object state parameter uₖ (k=1, 2, . . . , K) can be calculated based on the value of the argument u that gives the peak of an evaluation function given by one of Formulae (10) to (12), which are of the same forms as Formulae (3) to (5).

$$\begin{matrix} [ Formula 10 ] & \\ {P}_{BF} ( u ) = \frac{{a}^{H} ( u ) {R}_{all} a ( u )}{{a}^{H} ( u ) a ( u )} , & ( 10 ) \\ [ Formula 11 ] & \\ {P}_{CP} ( u ) = \frac{1}{{a}^{H} ( u ) {R}_{all}^{- 1} a ( u )} , ( Evaluation function of Capon method ) & ( 11 ) \\ [ Formula 12 ] & \\ {P}_{MU} = \frac{{a}^{H} ( u ) a ( u )}{{a}^{H} ( u ) {E}_{N} {E}_{N}^{H} a ( u )} , {E}_{N} = [ {e}_{K + 1} , … , {e}_{M} ] , & ( 12 )\end{matrix}$$

a(u) in Formulae (10) to (12) is given by M₀×a one-dimensional vector given by Formula (9). In Formula (12), eₙ (n=K+1, . . . , M) is a vector that has the minimum characteristic value, out of characteristic vectors of the correlation matrix Rₐₗₗ. The definition of M will be described later.

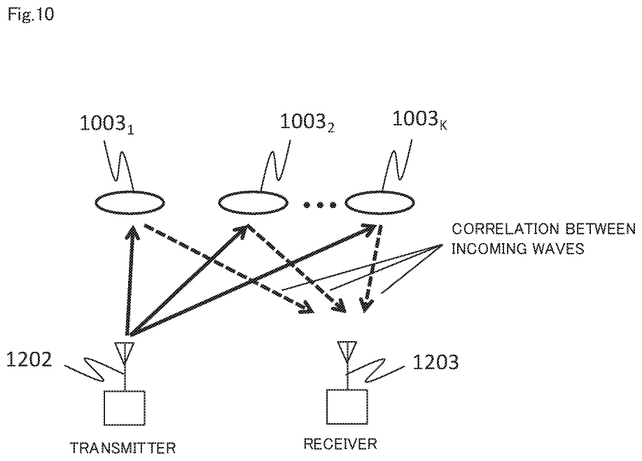

The following will describe how to obtain the correlation matrix Rₐₗₗ in Formulae (10) to (12), with reference to FIG. 10. FIG. 10 is a diagram illustrating a state in which reflected waves from the target objects are correlated with each other. As shown in FIG. 10, when the reflected waves from the different target objects 1003₁, 1003₂, . . . , 1003_{K} are correlated with each other, it is difficult to estimate the correct positions of the target objects 1003₁, 1003₂, . . . , 1003_{K}. This is because, when they are correlated, the same signals from the different target objects 1003₁, 1003₂, . . . , 1003_{K} are arrived at the receiving antenna 1203.

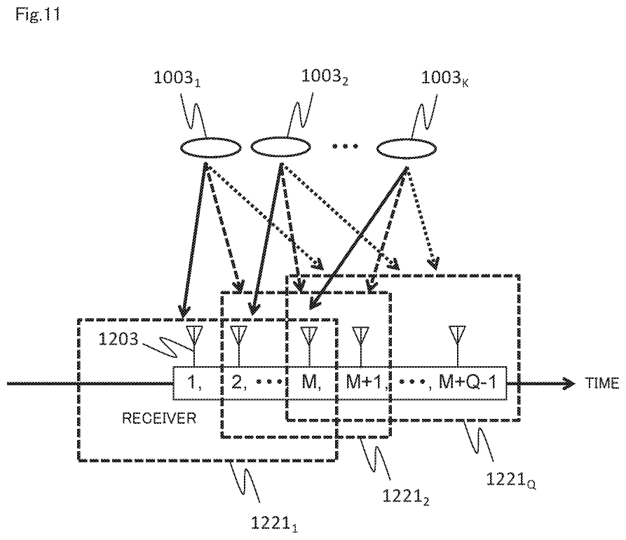

The problem regarding correlation between reflections inevitably occurs as long as radio waves are emitted to the target objects 1003₁, 1003₂, . . . , 1003_{K} from the same transmitter (transmitting antenna 1202). In contrast thereto, the problem regarding correlation between reflections can be avoided, as shown in FIG. 11, by configuring a plurality of sub arrays 1221₁, 1221₂, . . . , 1221_{Q} (Q is the number of sub arrays) with times, which serve as the argument of the reception signals, shifted from each other, and averaging correlation matrices calculated for the respective sub arrays. FIG. 11 is a diagram illustrating examples of sub arrays constituted by a plurality of virtual receiving antennas.

In FIG. 11, M is assumed to be the number of reception signals used in one sub array. The relationship M₀=Q+M−1 is satisfied between the number M₀ of all reception signals, the number M of reception signals used in one sub array, and the number Q of sub arrays.

Specifically, the q-th sub array is configured by reception signals of the q-th to (q+M−1)-th sub arrays, that is, by r_{q}=[r(t_{q}), r(t_{q+1}), . . . , r(t_{q+M-1})]^{T}. M is also the number of times sampling is performed, of each sub array. The correlation matrix R_{col(q)} obtained based on the q-th sub array is calculated using Formula (13) below.

[Formula 13]

R_{col(q)}=r_{Q}·r_{Q}^{H}, (53)

It is assumed that an average of correlation matrices R_{col(q)} (q=1, 2, . . . , Q) of all of the sub arrays is defined as Rₐₗₗ. The number Q of sub arrays is set to be not smaller than the number K of target objects.

In the first example embodiment, a sub array 1221_{q} (q=1, 2, . . . , Q) is configured in which the reception signal r_{q}=[r(t_{q}), r(t_{q+1}), . . . , r(t_{q+M-1})]^{T} at each sampling time is regarded as a virtual receiving antenna.

In the above-described method, by utilizing the characteristics that the correlation between reception signals of different sub arrays weakens, the problem resulting from correlation between reflected waves is avoided.

The terms in step A3 “a spectrum in which a region of the position parameter and a region of the shape parameter of the target object are taken as domains” refer to evaluation functions given by Formulae (10) to (12). A domain of a spectrum is designated by the argument u=(R, Δ) of the evaluation functions, and thus is designated by the parameter R indicating the position of the target object, and the parameter A indicating the shape of the target object. In step A3, it is sufficient to calculate an evaluation function given by one of Formulae (10) to (12), that is, a spectrum.

Furthermore, in step A3, the spectrum calculation unit 1103 takes the reception IF signal that is generated by the receiving unit 1102 and is given by Formulae (6) to (8). The spectrum calculation unit 1103 calculates, based on the reception IF signal, an evaluation function given by one of Formulae (10) to (12), that is, and a spectrum.

[Step A4]

In step A4, values of the position parameter and the shape parameter of the target object 1003 are calculated, based on the spectrum calculated in step A3, that is, an evaluation function given by one of Formulae (10) to (12). The following will describe step A4 in detail.

As already described in the description of step A3, the value of the target object state parameter uₖ (k=1, 2, . . . , K) can be calculated based on the value of the argument u that gives the peak of the evaluation function given by each of Formulae (10) to (12).

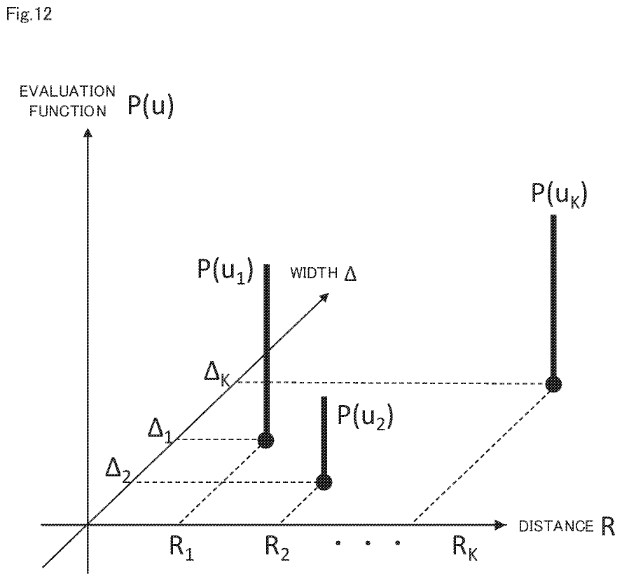

That is, if the distance and the width of the target object 1003ₖ (k=1, 2, . . . , K) are respectively set to Rₖ and Δₖ, the evaluation functions P(u) given by Formulae (10) to (12) have, as shown in FIG. 12, the peak at the two-dimensional point uₖ=(Rₖ, Δₖ) (k=1, 2, . . . , K), which correspond to the position Rₖ and the width Δₖ of the target object 1003ₖ. FIG. 12 is a graph of evaluation functions with the positions R and the widths Δ of the target objects taken as arguments.

Therefore, in step A4, the parameter value calculation unit 1107 calculates, based on the position of the point that gives the peak of the evaluation function P(u) calculated in step A3, the value of the position Rₖ and the value of the width Δₖ of the target object 1003ₖ.

More specifically, in step A4, the parameter value calculation unit 1107 receives the evaluation function that was calculated in step A3 and is given by one of Formulae (10) to (12), that is, the spectrum. Then, the parameter value calculation unit 1107 calculates, based on the peak position of the received evaluation function given by one of Formulae (10) to (12), that is, the spectrum, the value of the position Rₖ and the value of the width Δₖ of the target object 1003ₖ.

[Step A5]

In step A5, the calculation result output unit 1108 receives, from the parameter value calculation unit 1107, information relating to the position Rₖ and the width Δₖ of the target object 1003ₖ (k=1, 2, . . . , K) that were calculated in step A4, and outputs the received information. Specifically, the calculation result output unit 1108 outputs the received information as numerical value data or image data. The output destination is the system on which the object detection apparatus 1000 is installed.

[Effects of First Example Embodiment]

The following will summarize effects of the first example embodiment. A typical conventional millimeter-wave imaging device according to the array antenna method requires a larger number (several thousands to several tens of thousands) of antennas than in the first example embodiment to perform estimation of the incoming direction (angular direction) of received radio waves and detect the shape of a target object. On the other hand, in contrast to the conventional method of estimating the incoming direction of radio waves, that is, measuring the angular direction, the first example embodiment employs a method for detecting information relating to the shape, such as the width, of a target object based on the result of measurement of the distance from the transmitting/receiving device to the target object.

With the method according to the first example embodiment that does not need to measure the angular direction, the problem of the conventional method that measures the angular direction, that is, the problem of trade-off occurring between the aperture size D of antennas and resolution in angular direction measurement (incoming direction estimation) can be solved. As a result, the first example embodiment realizes a radar method that can not only recognize the position of a target object but also detect information relating to the shape, such as the width, of the target object, while using a small radar device with a few (to several) antennas. Furthermore, the information relating to the shape, such as the width, of the target object that was detected using the present radar method can be used for identifying the type of the target object (such as a car or a foot passenger, for example). Furthermore, the first example embodiment realizes a significant reduction in the actual number of antennas compared to a conventional millimeter-wave imaging device according to the array antenna method, thus achieving significant reductions in the size, weight, and cost of the device.

Furthermore, in the first example embodiment, a desired function can be realized by electronically scanning a two-dimensional variable u=(R, Δ), which is a pair of the distance R and the width Δ, in the arithmetic device 1211, without using mechanical scanning. Thus, the first example embodiment can have advantages such that a higher scan rate can be realized than that of mechanical scanning, the device can be downsized since there is no need to provide a device for mechanically moving the antenna, and the lifetime and maintenance cost of the device can be improved compared to mechanical scanning, since the mechanism does not wear out.

[Program]

A program according to the first example embodiment is preferably a program that causes a computer, namely, the arithmetic device 1211 to execute steps A3 to A5 shown in FIG. 7. By installing this program onto the arithmetic device 1211 and executing it, the object detection apparatus and the object detection method according to the first example embodiment can be realized. In this case, a Central Processing Unit (CPU) of the arithmetic device 1211 functions as the spectrum calculation unit 1103, the parameter value calculation unit 1107, and the calculation result output unit 1108, and performs processing.

Furthermore, the program according to the first example embodiment may also be executed by a computer system constituted by a plurality of computers. In this case, for example, each of the computers may also function as any one of the spectrum calculation unit 1103, the parameter value calculation unit 1107, and the calculation result output unit 1108.

### Second Example Embodiment

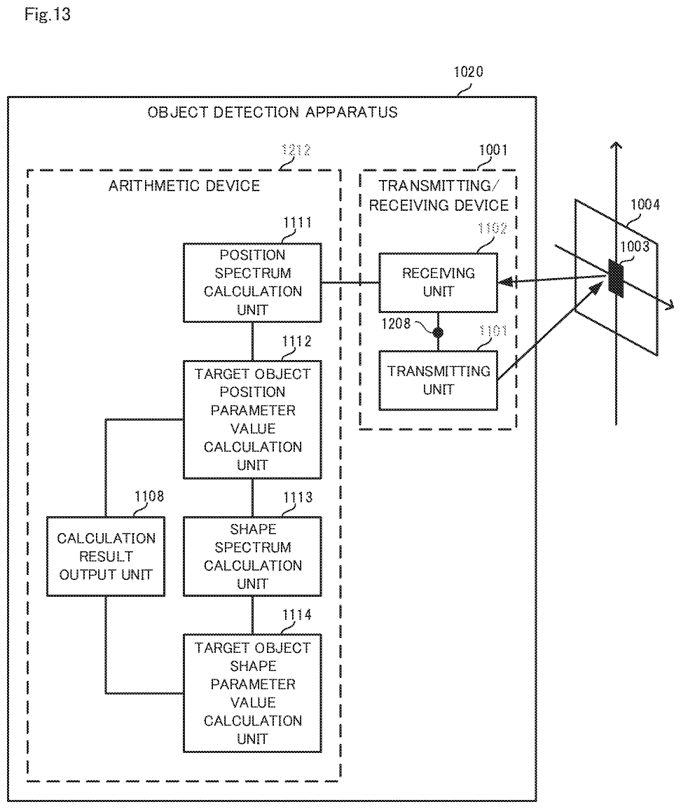

Hereinafter, an object detection apparatus, an object detection method, and a program according to a second example embodiment of the invention will be described with reference to FIGS. 13 to 16. In the following, descriptions of components common to those of the first example embodiment are omitted.

[Apparatus Configuration]

First, a configuration of the object detection apparatus according to the second example embodiment will be described with reference to FIG. 13. FIG. 13 is a block diagram illustrating a configuration of the object detection apparatus according to the second example embodiment.

As shown in FIG. 13, an object detection apparatus 1020 according to the second example embodiment is provided with the transmitting/receiving device 1001, which is the same as that of the first example embodiment. The transmitting/receiving device 1001 emits (transmits) radio waves to the target object 1003, and receives the radio waves reflected off the target object 1003 to generate, based on the received radio waves, IF signals. The IF signals are input to an arithmetic device 1212.

On the other hand, as shown in FIG. 13, the arithmetic device 1212 of the object detection apparatus 1020 according to the second example embodiment is different from the arithmetic device 1211 according to the first example embodiment shown in FIG. 1. In the second example embodiment, the arithmetic device 1212 is provided with, instead of the spectrum calculation unit 1103 and the parameter value calculation unit 1107 shown in FIG. 1, a position spectrum calculation unit 1111, a target object position parameter value calculation unit 1112, a shape spectrum calculation unit 1113, and a target object shape parameter value calculation unit 1114. Similar to the arithmetic device 1211, the arithmetic device 1212 is also provided with the calculation result output unit 1108. The following will mainly describe differences from the first example embodiment.

The position spectrum calculation unit 1111 calculates, based on the IF signals generated by the transmitting/receiving device 1001, a spectrum in which a region of a position parameter of the target object 1003 is taken as a domain (hereinafter, referred to as “position spectrum”).

The target object position parameter value calculation unit 1112 calculates, based on the position spectrum calculated by the position spectrum calculation unit 1111, the value of the position parameter of the target object 1003.

The shape spectrum calculation unit 1113 calculates, based on the IF signals generated by the transmitting/receiving device 1001 and the value of the position parameter of the target object 1003 calculated by the target object position parameter value calculation unit 1112, a spectrum in which a region of the shape parameter of the target object 1003 is taken as a domain (hereinafter, referred to as “shape spectrum”).

The target object shape parameter value calculation unit 1114 calculates, based on the shape spectrum calculated by the shape spectrum calculation unit 1113, the value of the shape parameter of the target object 1003.

The values of the position parameter of the target object 1003 calculated by the target object position parameter value calculation unit 1112 and the value of the shape parameter of the target object 1003 calculated by the target object shape parameter value calculation unit 1114 are transferred to the calculation result output unit 1108. The calculation result output unit 1108 outputs the transferred values of the position parameter and the shape parameter of the target object 1003.

Note that, also in the second example embodiment, as in the first example embodiment, the format of output of the parameter values by the calculation result output unit 1108 is not particularly limited. Also in the second example embodiment, the position spectrum calculation unit 1111, the target object position parameter value calculation unit 1112, the shape spectrum calculation unit 1113, the target object shape parameter value calculation unit 1114, and the calculation result output unit 1108 are configured by implementing a later-described program according to the second example embodiment into the arithmetic device (computer) 1212.

As described above, also in the second example embodiment, spectra in which a region of the position parameter and a region of the shape parameter of the target object 1003 are respectively taken as domains are calculated, and values of the position parameter and the shape parameter of the target object 1003 are calculated based on the spectra. In other words, also according to the second example embodiment, it is possible to calculate the value of the position parameter of the target object 1003 and the value of the shape parameter thereof, using a minimum configuration with a single transmitting unit 1101 and a single receiving unit 1102. Accordingly, also in the second example embodiment, as in the first example embodiment, it is possible to improve the accuracy of detecting an object using radio waves, while suppressing increases in the device cost, size, and weight.

[Apparatus Operation]

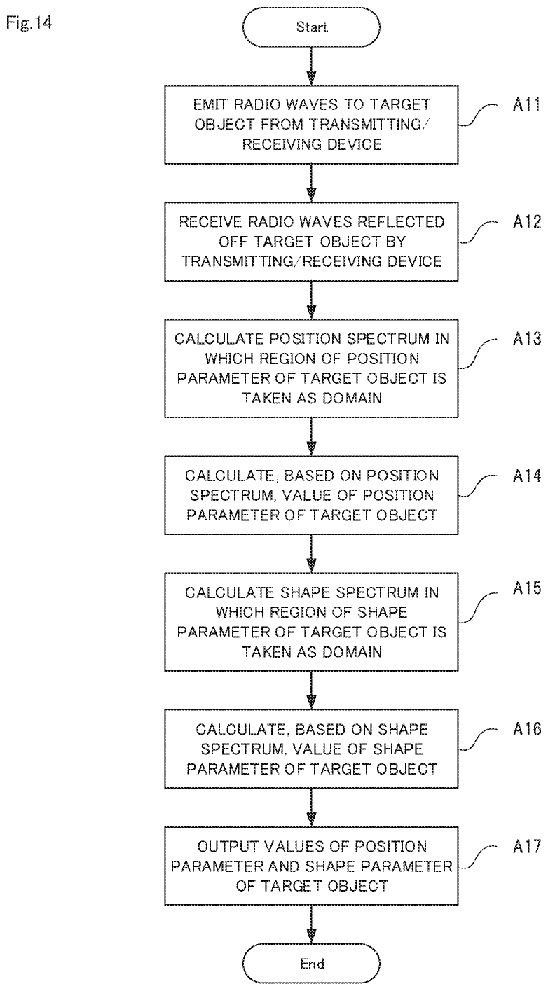

The following will describe an operation of the object detection apparatus 1020 according to the second example embodiment with reference to FIG. 14. FIG. 14 is a flow diagram illustrating an operation of the object detection apparatus according to the second example embodiment of the invention. In the following description, FIG. 13 is referenced as needed. Furthermore, in the second example embodiment, an object detection method is executed by operating the object detection apparatus 1020. Accordingly, the description of the object detection method according to the second example embodiment is replaced by the following description of the operation of the object detection apparatus 1020.

As shown in FIG. 14, first, the transmitting unit 1101 of the transmitting/receiving device 1001 emits, to the target object 1003, radio waves that serve as transmission signals (step A11). Then, the receiving unit 1102 of the transmitting/receiving device 1001 receives the radio waves reflected off the target object 1003 as reception signals, and mixes the transmission signals generated by the transmitting unit 1101 with the received reception signals to generate IF signals (step A12). Steps A11 and A12 are the same as steps A1 and A2 shown in FIG. 6.

Then, the position spectrum calculation unit 1111 calculates, based on the IF signals generated in step A12, a position spectrum in which a region of the position parameter of the target object 1003 is taken as a domain (step A13).

Then, the target object position parameter value calculation unit 1112 calculates, based on the position spectrum calculated in step A13, the value of the position parameter of the target object 1003 (step A14). The target object position parameter value calculation unit 1112 also transfers the calculated value of the position parameter to the calculation result output unit 1108.

Then, the shape spectrum calculation unit 1113 calculates, based on the IF signals generated in step A2 and the value of the position parameter of the target object 1003 calculated in step A14, a shape spectrum in which a region of the shape parameter of the target object 1003 is taken as a domain (step A15).

Then, the target object shape parameter value calculation unit 1114 calculates, based on the shape spectrum calculated in step A15, the value of the shape parameter of the target object 1003 (step A16). The target object shape parameter value calculation unit 1114 also transfers the calculated value of the shape parameter to the calculation result output unit 1108.

Then, the calculation result output unit 1108 outputs the value of the position parameter calculated in step A14, and the value of the shape parameter calculated in step A16 (step A17).

In this way, in the second example embodiment, the position spectrum calculation unit 1111 and the shape spectrum calculation unit 1113 function as the spectrum calculation unit 1103 of the first example embodiment. Also, in the second example embodiment, the target object position parameter value calculation unit 1112 and the target object shape parameter value calculation unit 1114 function as the parameter value calculation unit 1107 of the first example embodiment.

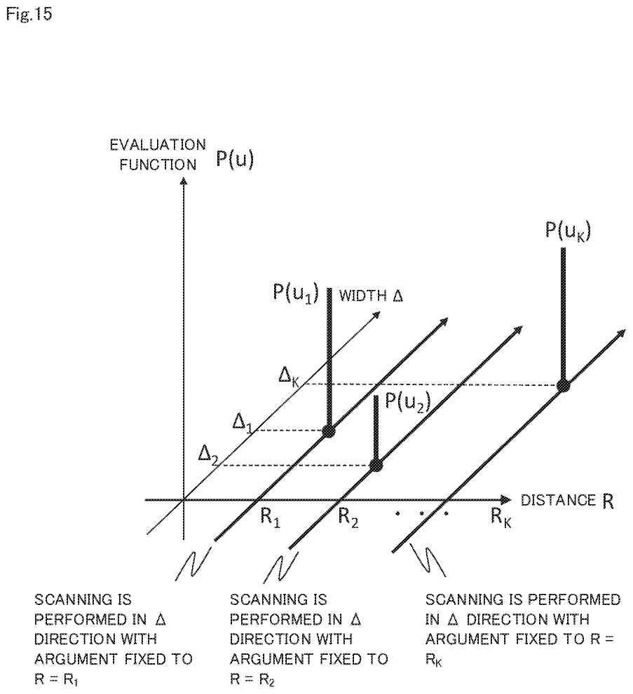

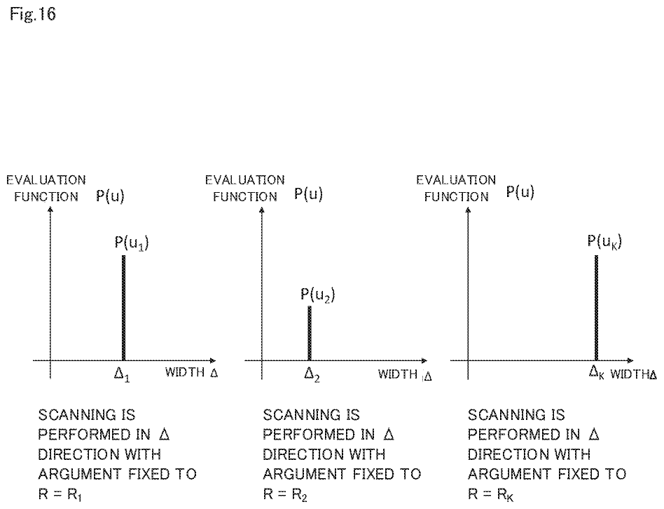

The following will describe steps A13 to A17 shown in FIG. 14 in more detail with reference to FIGS. 15 to 16.

[Step A13]

First, step A13 of calculating a spectrum in which a region of the position parameter of the target object 1003 is taken as a domain (position spectrum) based on transmitted and received radio waves will be described in detail.

As already described in the first example embodiment, in the system shown in FIG. 7, the transmitting/receiving device 1001 acquires an IF signal given by Formula (6).

In step A13 of the second example embodiment, the IF signal given by Formula (6) is subjected to approximation in which the value of the width Δₖ of the target object 1003ₖ (k=1, 2, . . . , K) is regarded as 0 and thus is disregarded. At this time, the IF signal given by Formula (6) is modified as indicated by Formula (14).

$$\begin{matrix}[ Formula 14 ] & \\ r ( t ) = {\sum }_{k = 1}^{K} σ ( {R}_{k} ) h ( {R}_{k} , t ) , \\ h ( {R}_{k} , t ) ≡ \frac{cos [ 4 π ( {f}_{min} + {αt}^{′} ) {R}_{k} / c ]}{{R}_{k} \sqrt{{R}_{k}^{2} - {z}^{2}}} , & ( 14 )\end{matrix}$$

Here, the reflectance σ(R) with the distance R taken as an argument has a nonzero value at the distance Rₖ at which the target object 1003ₖ (k=1, 2, . . . , K) is present, and is zero at positions other than the distance Rₖ.

Here, if the distance Rₖ (k=1, 2, . . . , K) at which the reflectance σ(R) is nonzero can be obtained, the distance Rₖ of the target object 1003ₖ (k=1, 2, . . . , K) can be calculated based on the value of Rₖ.

The following will describe a method for obtaining the distance Rₖ (k=1, 2, . . . , K) at which the reflectance σ(R) is nonzero.

Formula (14) can be rewritten into Formula (15) below. In Formula (15) below, n is a vector whose element is noise content.

$$\begin{matrix}[ Formula 15 ] & \\ \begin{matrix}r = As + n , & \\ r ≡ {[ r ( {t}_{1} ) , r ( {t}_{2} ) , … , r ( {t}_{M 0} ) ]}^{T} , & \\ s ≡ {[ σ ( {R}_{1} ) , σ ( {R}_{2} ) , ⋯ , σ ( {R}_{K} ) ]}^{T} , & \\ A ≡ ( a ( {R}_{1} ) , a ( {R}_{2} ) , … , a ( {R}_{K} ) ) , & \\ a ( R ) ≡ {[ h ( R , {t}_{1} ) , h ( R , {t}_{2} ) , … , hR ( u , {t}_{M 0} ) ]}^{T} , & \\ h ( R , t ) ≡ \frac{cos [ 4 π ( {f}_{min} + α {t}_{m} ) R / c ]}{R \sqrt{{R}^{2} - {z}^{2}}} , & ( m = 1 , 2 , … , {M}_{0} )\end{matrix} \} & ( 15 )\end{matrix}$$

Formula (15) of the second example embodiment is compared with Formula (9) of the first example embodiment. In this case, Formula (9) and Formula (15) are of the same form, except for the argument of the reflectance σ being a two-dimensional variable u=(R, Δ) in Formula (9) and being a distance variable R in Formula (15). Accordingly, using Formulae (16) to (18), which are the same evaluation functions as those of Formulae (10) to (12), the position Rₖ of the target object 1003ₖ (k=1, 2, . . . , K) can be detected.

$$\begin{matrix}[ Formula 16 ] & \\ {P}_{BF} ( R ) = \frac{{a}^{H} ( R ) {R}_{all} a ( R )}{{a}^{H} ( R ) a ( R )} , ( Evaluation function of beam former method ) & ( 16 ) \\ [ Formula 17 ] & \\ {P}_{CP} ( R ) = \frac{1}{{a}^{H} ( R ) {R}_{all}^{- 1} a ( R )} , ( Evaluation function of Capon method ) & ( 17 ) \\ [ Formula 18 ] & \\ {P}_{MU} ( R ) = \frac{{a}^{H} ( R ) a ( R )}{{a}^{H} ( R ) {E}_{N} {E}_{N}^{H} a ( R )} , {E}_{N} = [ {e}_{K + 1} , … , {e}_{M} ] , & ( 18 )\end{matrix}$$

Since the methods for obtaining the correlation matrices Rₐₗₗ in Formulae (16) to (18) are the same as in the first example embodiment, descriptions thereof are omitted here.

In step A13, using the evaluation function given by one of Formulae (16) to (18), the position Rₖ of the target object 1003ₖ (k=1, 2, . . . , K) is detected based on the value of the argument R that gives the peak of the evaluation function.

The terms in step A3 “a spectrum (position spectrum) in which a region of the position parameter of the target object is taken as a domain” refer to evaluation functions given by Formulae (16) to (18). A domain of a spectrum is designated by the argument R of the evaluation functions, and thus is designated by the parameter R indicating the position of the target object. In step A13, it is sufficient to calculate an evaluation function given by one of Formulae (16) to (18), that is, a position spectrum.

In step A13, the position spectrum calculation unit till takes the reception IF signal that is generated by the receiving unit 1102 and is given by Formula (14). The position spectrum calculation unit till calculates, based on the reception IF signal, the evaluation function given by one of Formulae (16) to (18), that is, the position spectrum.

[Step A14]

In step A14, the value of the position parameter of the target object are calculated, based on the position spectrum, that is, the evaluation function given by one of Formulae (16) to (18). The following will describe step A14 in detail.

As already described in the description of step A13, the value of the distance Rₖ (k=1, 2, . . . , K) of the target object can be calculated based on the value of the argument R that gives the peak of the evaluation function given by each of Formulae (16) to (18).

More specifically, in step A14, an evaluation function that is given by one of Formulae (16) to (18) and is calculated by the position spectrum calculation unit 1111, that is, a position spectrum is given to the target object position parameter value calculation unit 1112. The target object position parameter value calculation unit 1112 calculates the value of the position Rₖ of the target object 1003ₖ, based on the peak position of the evaluation function that was received from the position spectrum calculation unit 1111 and is given by one of Formulae (16) to (18), that is, the spectrum.

[Step A15]

The following will describe step A15 of calculating a shape spectrum in which a shape parameter of the target object 1003 is taken as a domain, based on the IF signal obtained on the basis of the transmitted and received radio waves and the information relating to the position of the target object 1003 that was obtained in step A4, in detail with reference to FIGS. 15 and 16. FIG. 15 is a diagram illustrating a method for scanning an argument of an evaluation function. FIG. 16 illustrates evaluation function graphs in which the width Δ of a target object is taken as an argument.

In step A15, the shape spectrum calculation unit 1113 calculates, based on the IF signal that is given by one of Formulae (6) to (8) and is obtained by the transmitting/receiving device 1001, an evaluation function given by one of Formulae (10) to (12) according to the first example embodiment.

Note however that, in step A15 according to the second example embodiment, using information relating to the position Rₖ (k=1, 2, . . . , K) of the target object 1003ₖ that was obtained in step A14, scanning is performed only in a Δ direction, while the range of the argument of the evaluation function in which scanning is performed being fixed to R=Rₖ, as show in FIG. 15. As a result, as shown in FIG. 16, for each target object 1003ₖ (k=1, 2, . . . , K), a spectrum in which the width Δ of the target object, that is, a shape parameter is taken as an argument (=domain), that is, a shape spectrum is obtained.

Also, as shown in FIG. 16, the shape spectra of each target object 1003ₖ (k=1, 2, . . . , K) take the peaks at Δ=Δₖ. Here, Δₖ is a value of the width of each target object 1003ₖ.

In step A15, the IF signals generated by the transmitting/receiving device 1001 in step A12, and the value of the position parameter of the target object 1003 generated by the target object position parameter value calculation unit 1112 in step A14 are transferred to the shape spectrum calculation unit 1113. Also, the shape spectrum calculation unit 1113 calculates a shape spectrum based on the above-described procedure.

[Step A16]

The following will describe details of step A16 of calculating the value of the shape parameter of the target object 1003 based on the shape spectrum.

In step A6, the shape spectrum calculation unit 1113 transfers the shape spectrum to the target object shape parameter value calculation unit 1114 in step A15. Accordingly, in step A16, the target object shape parameter value calculation unit 1114 calculates the width Δₖ of each target object 1003ₖ, that is, the shape parameter, based on the value of A at which the shape spectrum of each target object 1003ₖ (k=1, 2, . . . , K) takes the peak.

[Step A17]

The following will describe details of step A17 of outputting the calculated values of the position parameter and the shape parameter of the target object.

In step A17, the calculation result output unit 1108 first receives the information relating to the position Rₖ (value of the position parameter) of each target object 1003ₖ calculated by the target object position parameter value calculation unit 1112 in step A14. The calculation result output unit 1108 also receives the information relating to the width Δₖ (value of the shape parameter) of each target object 1003ₖ calculated by the target object shape parameter value calculation unit 1114 in step A6.

Then, the calculation result output unit 1108 outputs the information relating to the position Rₖ of the target object 1003ₖ (k=1, 2, . . . , K) and the information relating to the width Δₖ thereof. Specifically, the calculation result output unit 1108 outputs the received information as numerical value data or image data. The output destination is a system on which the object detection apparatus 1020 is installed.

[Effects of Second Example Embodiment]

Also the second example embodiment can realize the effects described in the first example embodiment. That is, the second example embodiment also realizes a radar method that can not only recognize the position of a target object but also detect information relating to the shape, such as the width, of the target object, while using a small radar device with a few (to several) antennas. Furthermore, the information relating to the shape, such as the width, of the target object that was detected using the present radar method can be used for identifying the type of the target object (such as a car or a foot passenger, for example).

Furthermore, the second example embodiment also realizes a significant reduction in the actual number of antennas compared to a conventional millimeter-wave imaging device according to the array antenna method, thus achieving significant reductions in the size, weight, and cost of the device.

Furthermore, also in the second example embodiment, since electronic scanning is used instead of mechanical scanning, it is possible to achieve advantageous effects of increasing the scan rate, downsizing the device, extending the lifetime of the device, and improving the maintenance cost, compared to a method using mechanical scanning.

[Program]

A program according to the second example embodiment is preferably a program that causes a computer, namely, the arithmetic device 1212 to execute steps A13 to A17 shown in FIG. 14. By installing this program onto the arithmetic device 1212 and executing it, the object detection apparatus and the object detection method according to the second example embodiment can be realized. In this case, a Central Processing Unit (CPU) of the arithmetic device 1212 functions as the position spectrum calculation unit 1111, the target object position parameter value calculation unit 1112, the shape spectrum calculation unit 1113, the target object shape parameter value calculation unit 1114, and the calculation result output unit 1108, and performs processing.

Furthermore, the program according to the second example embodiment may also be executed by a computer system constituted by a plurality of computers. In this case, for example, each of the computers may also function as any one of the position spectrum calculation unit 1111, the target object position parameter value calculation unit 1112, the shape spectrum calculation unit 1113, the target object shape parameter value calculation unit 1114, and the calculation result output unit 1108.

### Third Example Embodiment

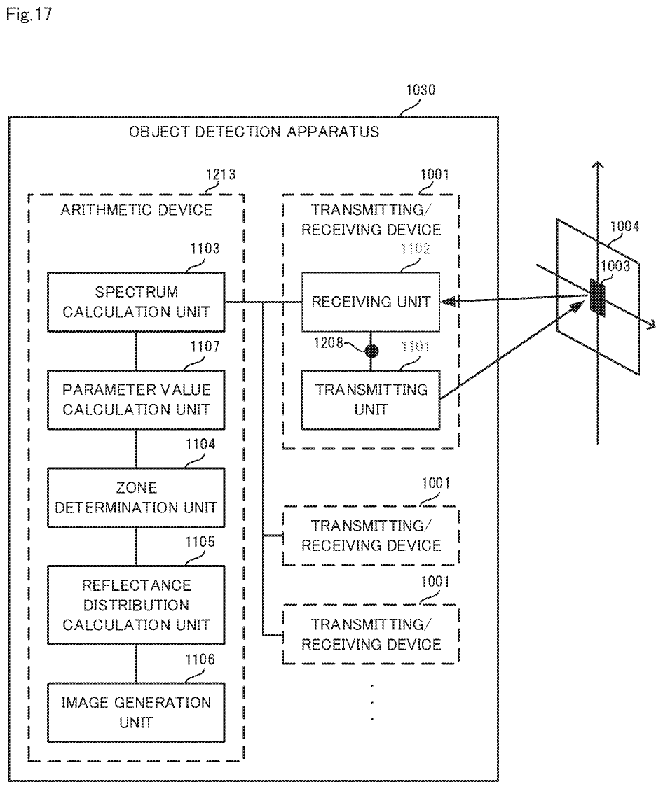

Hereinafter, an object detection apparatus, an object detection method, and a program according to a third example embodiment of the invention will be described with reference to FIGS. 17 to 23. Also, in the third example embodiment, as in the above-described first and second example embodiments, it is possible to not only recognize the position of a target object but also detect the shape of the target object while using a small radar device, as is the case of a conventional millimeter-wave imaging device. In the following, descriptions of components common to those of the first example embodiment are omitted.

[Apparatus Configuration]

First, a configuration of the object detection apparatus according to the third example embodiment will be described with reference to FIG. 17. FIG. 17 is a block diagram illustrating a configuration of the object detection apparatus according to the third example embodiment of the invention.

Similar to the object detection apparatus 1000 according to the first example embodiment, an object detection apparatus 1030 according to the third example embodiment shown in FIG. 17 is a device for detecting an object using radio waves. As shown in FIG. 17, the object detection apparatus 1030 according to the third example embodiment is provided with the transmitting/receiving devices 1001 and an arithmetic device 1213, as in the first example embodiment.

Note however that the object detection apparatus 1030 according to the third example embodiment differs from the object detection apparatus 1000 according to the first example embodiment in the configuration and function of the arithmetic device 1213. The following will mainly describe the differences from the first example embodiment.

As shown in FIG. 17, in the third example embodiment, the object detection apparatus 1030 is provided with a plurality of transmitting units 1101 and a plurality of receiving units 1102. Furthermore, the plurality of receiving units 1102 are respectively associated with the plurality of transmitting units 1101. In other words, the object detection apparatus 1030 is provided with a plurality of transmitting/receiving devices 1001.

The arithmetic device 1213 is provided with, in addition to the spectrum calculation unit 1103 and the parameter value calculation unit 1107, a zone determination unit 1104, a reflectance distribution calculation unit 1105, and an image generation unit 1106. Note that, in the third example embodiment, the calculation result output unit 1108 used in the first example embodiment is omitted.

Also, in the object detection apparatus 1030 shown in FIG. 17, one arithmetic device 1213 is provided for a plurality of transmitting/receiving devices 1001, but an arithmetic device 1213, or an element constituting it may also be provided for each of the transmitting/receiving devices 1001.

Also in the third example embodiment, the spectrum calculation unit 1103 calculates, based on an IF signal, a spectrum in which a region of the position parameter of the target object 1003 and a region of the shape parameter thereof are taken as domains, in accordance with the procedure shown in the first example embodiment.

Also, the parameter value calculation unit 1107 calculates, based on the spectrum calculated by the spectrum calculation unit 1103, the value of the position parameter of the target object 1003 and the value of the shape parameter thereof, in accordance with the procedure shown in the first example embodiment.

The zone determination unit 1104 determines, based on the values of the position parameter and the shape parameter of the target object 1003 that were calculated by the parameter value calculation unit 1107, zones for calculating the reflectance of the target object 1003.

The reflectance distribution calculation unit 1105 calculates, for each pair of transmitting unit 1101 and associated receiving unit 1102, that is, for each transmitting/receiving device 1001, the reflectance of the target object 1003 in each of the determined zones based on the IF signals.

The image generation unit 1106 calculates the product of distributions of the reflectance over the zones for the respective pairs. The image generation unit 1106 also generates an image of the target object 1003 using the product of distributions of the reflectance calculated for the respective pairs.

Also in the third example embodiment, as in the first example embodiment, the spectrum calculation unit 1103, the parameter value calculation unit 1107, the zone determination unit 1104, the reflectance distribution calculation unit 1105, and the image generation unit 1106 are configured by implementing a later-described program according to the third example embodiment into the arithmetic device (computer) 1213.

As such, also in the third example embodiment, a spectra that indicate the position and the shape of the target object 1003 is calculated, and based on the spectrum, values of the position parameter and the shape parameter of the target object 1003 are calculated. Then, zones for calculating the reflectance of the target object 1003 are determined based on the value of the position parameter of the target object 1003 and the value of the shape parameter thereof, and an image of the target object 1003 is formed based on the product of distributions of reflectance over the zones. Therefore, according to the third example embodiment, it is possible to improve the accuracy of detecting an object using radio waves, while suppressing increases in the device cost, size, and weight.

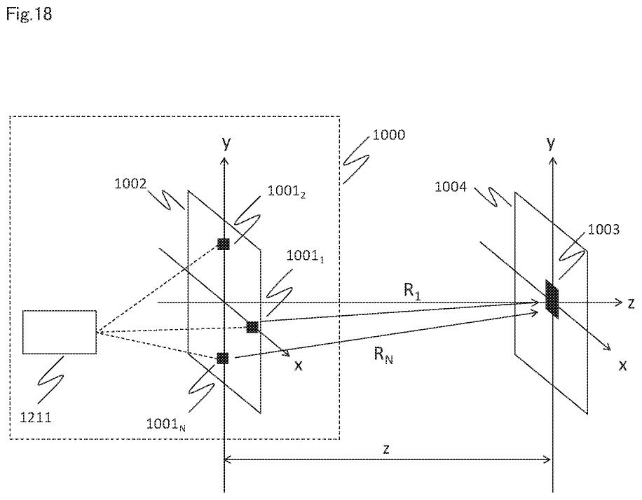

Subsequently, the configuration of the object detection apparatus according to the third example embodiment will be described more specifically with reference to FIG. 18, in addition to FIG. 17. FIG. 18 is a diagram schematically illustrating a configuration of an outer appearance of the object detection apparatus according to the third example embodiment of the invention.

As shown in FIG. 18, in the third example embodiment, a plurality of transmitting/receiving devices 1001₁, 1001₂, . . . , 1001_{N} are arranged on the transmitting/receiving device arranged plane 1002. The transmitting/receiving devices 1001₁, 1001₂, . . . , 1001_{N} are connected to the arithmetic device 1213. Here, N is the number of arranged transmitting/receiving devices 1001. Furthermore, the target object 1003 is assumed to be arranged on the target object arranged plane 1004.

In this case, the transmitting/receiving devices 1001₁, 1001₂, . . . , 1001_{N} emit radio waves to the target object 1003. Then, the transmitting/receiving devices 1001₁, 1001₂, . . . , 1001_{N} are assumed to receive the radio waves reflected off the target object 1003. Also, the transmitting/receiving devices 1001₁, 1001₂, . . . , 1001_{N} respectively measure, based on the transmitted and received radio waves, distances R₁, R₂, . . . , RN between the respective transmitting/receiving devices 1001₁, 1001₂, . . . , 1001_{N} and the target object 1003, and the width Δ₁, Δ₂, . . . , Δ_{N} of the target object 1003 viewed from the transmitting/receiving devices 1001₁, 1001₂, . . . , 1001_{N}.

Also in the third example embodiment, as in the first example embodiment, if a plurality of transmitting/receiving devices 1001₁, 1001₂, . . . , 1001_{N} (N is the number of transmitting/receiving devices 1001) are used, it is preferable that each of the transmitting/receiving devices 1001₁, 1001₂, . . . , 1001_{N} be controlled so as not to operate at the same time as another transmitting/receiving device, in order to avoid interference between the transmitting/receiving devices 1001₁, 1001₂, . . . , 1001_{N}.

Furthermore, if each of the transmitting/receiving devices 1001₁, 1001₂, . . . , 1001_{N} operates in the same time period as the time period in which another transmitting/receiving device operates, it is preferable that control be performed such that, as shown in FIG. 5, the RF frequencies 1231₁, 1231₂, . . . , 1231_{N} of radio waves transmitted from the transmitting/receiving devices 1001₁, 1001₂, . . . , 1001_{N} are not identical.

[Apparatus Operation]

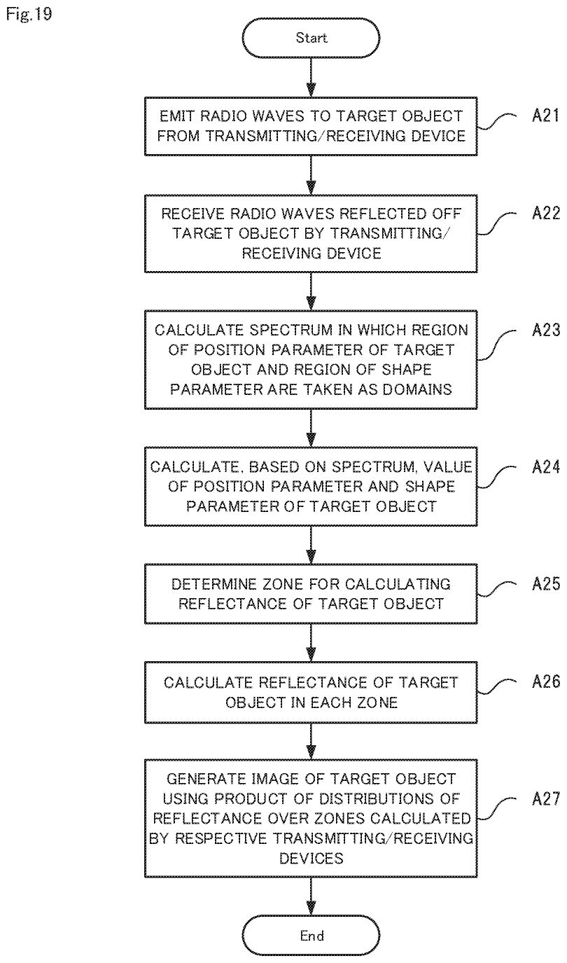

The following will describe an operation of the object detection apparatus 1030 according to the third example embodiment with reference to FIG. 19. FIG. 19 is a flow diagram illustrating an operation of the object detection apparatus according to the third example embodiment of the invention. In the following description, FIGS. 17 to 18 are referenced as needed. Furthermore, in the third example embodiment, an object detection method is executed by operating the object detection apparatus 1030. Accordingly, the description of the object detection method according to the third example embodiment is replaced by the following description of the operation of the object detection apparatus 1030.

As shown in FIG. 19, first, the transmitting unit 1101 of each of the transmitting/receiving devices 1001 emits, to the target object 1003, radio waves that serve as transmission signals (step A21). Step A21 is the same as step A1 shown in FIG. 6.

Then, the receiving unit 1102 of the corresponding transmitting/receiving device 1001 receives the radio waves reflected off the target object 1003 as reception signals, and mixes the transmission signals generated by the transmitting unit 1101 with the received reception signals to generate IF signals (step A22). Step A22 is the same as step A2 shown in FIG. 6.

Then, the spectrum calculation unit 1103 calculates, based on the IF signals generated in step A22, a spectrum (target object spectrum) in which a region of the position parameter of the target object 1003 and a region of the shape parameter thereof are taken as domains (step A23). Step A23 is the same as step A3 shown in FIG. 6.

Then, the parameter value calculation unit 1107 calculates, based on the target object spectrum calculated in step A23, the value of the position parameter of the target object 1003 and the value of the shape parameter thereof (step A24). Step A24 is the same as step A4 shown in FIG. 6.

Then, the zone determination unit 1104 determines, based on the values of the position parameter and the shape parameter of the target object 1003 that were calculated in step A24, zones for calculating the reflectance of the object 1003 (step A25).

Then, the reflectance distribution calculation unit 1105 calculates, for each pair of transmitting unit 1101 and associated receiving unit 1102, that is, for each transmitting/receiving device 1001, the reflectance of the target object 1003 in each of the zones determined in step A25, based on the IF signals (step A26).

Then, the image generation unit 1106 calculates the product of distributions of the reflectance over the zones for the respective pairs, and generates an image of the target object 1003 using the product of distributions of the reflectance calculated for the respective pairs (step Nil). The generated image is displayed on a picture plane of an image display device, or the like.

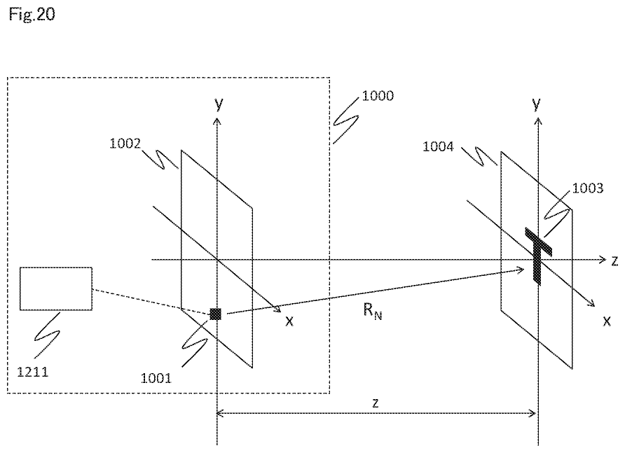

The following will describe steps A25 to Nil shown in FIG. 19 in details with reference to FIGS. 20 to 23.

[Step A25]

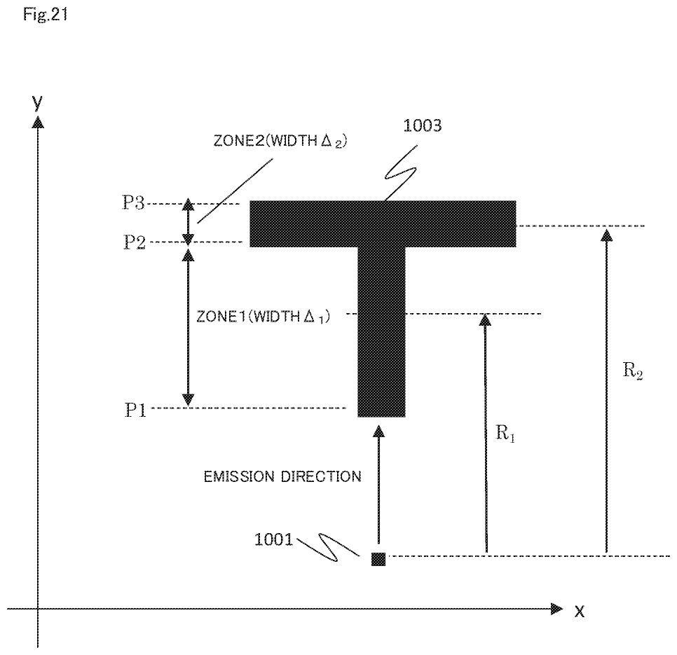

In describing step A25, a method for determining zones for calculating the effective reflectance of the target object 1003 will be described with reference to FIGS. 20 and 21, taking a layout in which the transmitting/receiving device 1001 is arranged on the y-axis of the transmitting/receiving device arranged plane 1002 as an example. FIG. 20 is a diagram illustrating, when a target object is T-shaped, a positional relationship between the target object and the transmitting/receiving device. FIG. 21 is a projection view obtained by projecting the target object shown in FIG. 20 onto an x-y plane along a z-axis direction.

In the example of FIG. 21, due to discontinuous boundaries P1 to P3 of the shape of the target object 1003 that is present in the direction in which the transmitting/receiving device 1001 performs emission, the target object 1003 is divided into two parts, namely, a zone 1 (between P1 and P2) and a zone 2 (between P2 and P3), and is detected by the transmitting/receiving device 1001. Also, in accordance with the procedure from steps A21 to A24 that is the same as the procedure from steps A1 to A4 described in detail in the first example embodiment, the position parameters R₁ and R₂ of the target object 1003 that are present in the zones 1 and 2, and the shape parameters Δ₁ and Δ₂ that correspond to the width of the target object are calculated.

In step A25, based on the position parameters R₁ and R₂ of the target object 1003 and the shape parameters Δ₁ and Δ₂ that correspond to the width of the target object that were obtained in the procedure from steps A21 to A24, the zone 1 and the zone 2 are determined. In other words, based on Formula (7) described in the first example embodiment, the zone 1 is determined as a region in which the distance from the transmitting/receiving device 1001 is in the range of sqrt(R₁+(Δ₁/2)²±zΔ₁), and the zone 2 is determined as a region in which the distance from the transmitting/receiving device 1001 is in the range of sqrt(R₂+(Δ₂/2)²±zΔ₂).

[Step A26]

The following will describe step A26. As indicated by Formula (9) shown in the first example embodiment, the relationship r=As is satisfied between a reception IF signal r=[r(t₁), r(t₂), . . . , r(t_{M0})]^{T}, the reflectance s=[σ(u₁), σ(u₂), . . . , σ(uₖ)]^{T} of the target object 1003, and a direction matrix A=(a(u₁), a(u₂), . . . , a(u_{K})). Note here that the noise content n is disregarded. The reception IF signal r is a measured value obtained in steps A21 to A22. The direction matrix A is a function of the target object state parameter u₁, u₂, . . . , u_{K}, and if the target object state parameter u₁, u₂, . . . , u_{K} is determined in step A24, the value of the direction matrix A is also determined. In other words, at a point in time when the processing of step A24 is complete, the reception IF signal r and the direction matrix A are determined.

Then, using all pieces of sampling data r=[r(t₁), r(t₂), . . . , r(t_{M0})]^{T} of the reception IF signal, the correlation matrix Rₐₗₗ₍₀₎ is calculated using Formula (19) below.

[Formula 19]

Rₐₗₗ₍₀₎=r·r^{H}, (19)

Based on Formula (19) and the relationship r=As, the relationship given by Formula (20) below is obtained.

[Formula 20]

Rₐₗₗ₍₀₎=A·S·A^{H},

S≡{sᵢⱼ}=σ(uᵢ)·{σ(uⱼ)}*, (20)

Furthermore, by applying the pseudo inverse matrix of A to Formula (20), S can be calculated by using Formula (21) below.

[Formula 21]

S=(A^{H}·A)⁻¹·A^{H}·R₀·A·(A^{H}·A)⁻¹, (21)

Based on the diagonal component of S obtained by Formula (21), the effective reflectance |σ(uₖ)|² (k=1, 2, . . . , K) of the target object for each zone can be obtained.

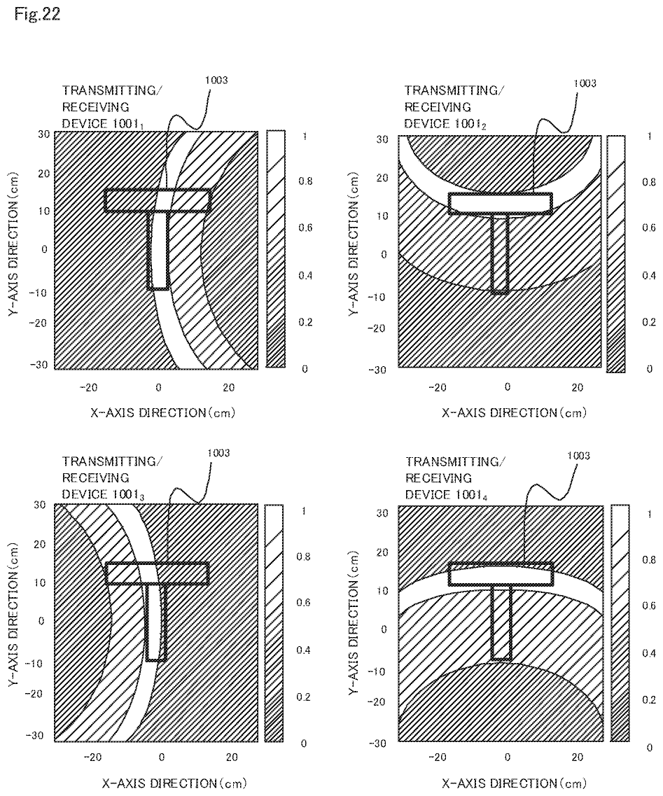

Here, the calculation results of the effective reflectance of the target object 1003 for the zones obtained in step A26 are shown in FIG. 22. FIG. 22 illustrates examples of the calculation results of the reflectance of the target object calculated in step A26 shown in FIG. 19. The examples of FIG. 22 show data obtained by four transmitting/receiving devices 1001₁ to 1001₄.

The transmitting/receiving devices 1001₁ to 1001₄ can respectively measure the positions of the target object 1003 in the distance direction (direction toward the target object when viewed from the transmitting/receiving devices 1001₁ to 1001₄). However, it is difficult for the transmitting/receiving devices 1001₁ to 1001₄ to measure the positions in the angular direction (direction toward a side of the target object when viewed from the transmitting/receiving devices 1001₁ to 1001₄). Accordingly, zones are defined only in the distance direction. Also, each zone is a region on the target object arranged plane 1004 that is enclosed by a circle whose origin is the point (O shown in FIG. 7) on the target object arranged plane 1004 at which the distance from the corresponding one of the transmitting/receiving devices 1001₁ to 1001₄ is the minimum. Because effective reflectance has the same value in a zone, they appear to have a doughnut-shaped distribution.

Effective reflectance is an amount that is proportional to the width, in the angular direction, and the reflectance of the target object 1003. Because the reflectance of the target object 1003 are uniform, the effective reflectance of the pattern of a larger width in the angular direction when viewed from the transmitting/receiving device 1001 has a particularly large value. For example, the transmitting/receiving device 1001₁ or 1001₃ is used to perform measurement, the effective reflectance of the vertical bar portion of the T-shaped target object 1003 is high. On the other hand, when the transmitting/receiving device 1001₂ or 1001₄ is used to perform measurement, the effective reflectance of the horizontal bar portion of the -shaped target object 1003 is high.

[Step A27]

The following will describe step A7. First, an effective reflectance distribution on an X-Y plane of a transmitting/receiving device 1001ₙ (n=1, 2, . . . , N, and in the example of FIG. 22, N=4) shown in FIG. 22 is set as σ′ₙ(x, y). The ultimately obtained image I(x, y) is calculated using the product of the effective reflectance distributions σ′ₙ(x, y) obtained for the transmitting/receiving devices 1001ₙ (n=1, 2, . . . , N), as shown in Formula (22).

$$I ( ϰ , y ) = {[ {\prod }_{n = 1}^{N} {σ}_{n}^{′} ( x , y ) ]}^{δ / N} , \qquad ( 22 )$$

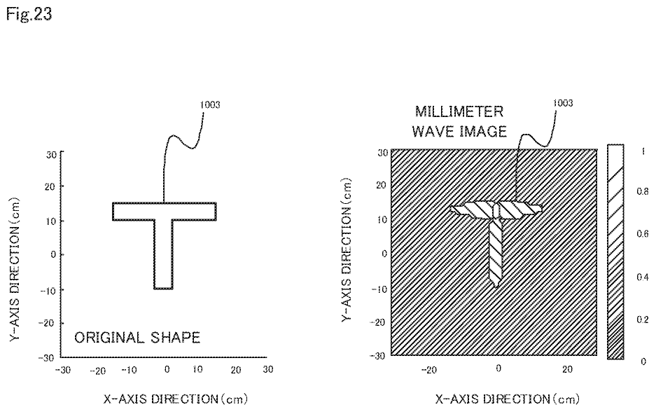

In Formula (22), δ is a parameter for adjusting a dynamic range of an image. A millimeter wave image obtained when δ=2 based on Formula (22) is shown in FIG. 23. FIG. 23 illustrates examples of images of the target object generated in the example embodiment of the invention. As shown in FIG. 23, in the third example embodiment, when the original shape is a T shape with a width of 5 cm, also the millimeter wave image obtained by measurement with the bandwidth 2 GHz has the same T shape as the original shape, as a result of executing steps A21 to A26.

[Effects of Third Example Embodiment]

Similar to the first example embodiment, also in the third example embodiment, a method for detecting information relating to the shape, such as the width, of the target object, based on a result of measurement of a distance between the transmitting/receiving device and a target object is used, in contrast to radio wave incoming direction estimation, that is, a conventional method for measuring an angular direction.

Thus, the third example embodiment also realizes a radar method that can not only recognize the position of a target object but also detect information relating to the shape, such as the width, of the target object, while using several small radar devices with a few (to several) antennas. Furthermore, in the third example embodiment, since an image showing the shape of the target object is formed, it is possible to detect and identify, for example, dangerous goods such as weapons concealed under clothes, in bags, or the like, as well or better than a conventional millimeter-wave imaging device.

Furthermore, similar to the first example embodiment, the third example embodiment also realizes a significant reduction in the actual number of antennas compared to a typical millimeter-wave imaging device according to the array antenna method, thus achieving significant reductions in the size, weight, and cost of the device. Additionally, also in the third example embodiment, since electronic scanning is used instead of mechanical scanning, it is possible to achieve advantageous effects of increasing the scan rate, downsizing the device, extending the lifetime of the device, and improving the maintenance cost, compared to a method using mechanical scanning.

[Program]

A program according to the third example embodiment is preferably a program that causes a computer, namely, the arithmetic device 1213 to execute steps A23 to A27 shown in FIG. 19. By installing this program onto the arithmetic device 1213 and executing it, the object detection apparatus and the object detection method according to the third example embodiment can be realized. In this case, a Central Processing Unit (CPU) of the arithmetic device 1213 functions as the spectrum calculation unit 1103, the parameter value calculation unit 1107, the zone determination unit 1104, the reflectance distribution calculation unit 1105, and the image generation unit 1106, and performs processing.

Furthermore, the program according to the third example embodiment may also be executed by a computer system constituted by a plurality of computers. In this case, for example, each of the computers may also function as any one of the spectrum calculation unit 1103, the parameter value calculation unit 1107, the zone determination unit 1104, the reflectance distribution calculation unit 1105, and the image generation unit 1106.

### Fourth Example Embodiment

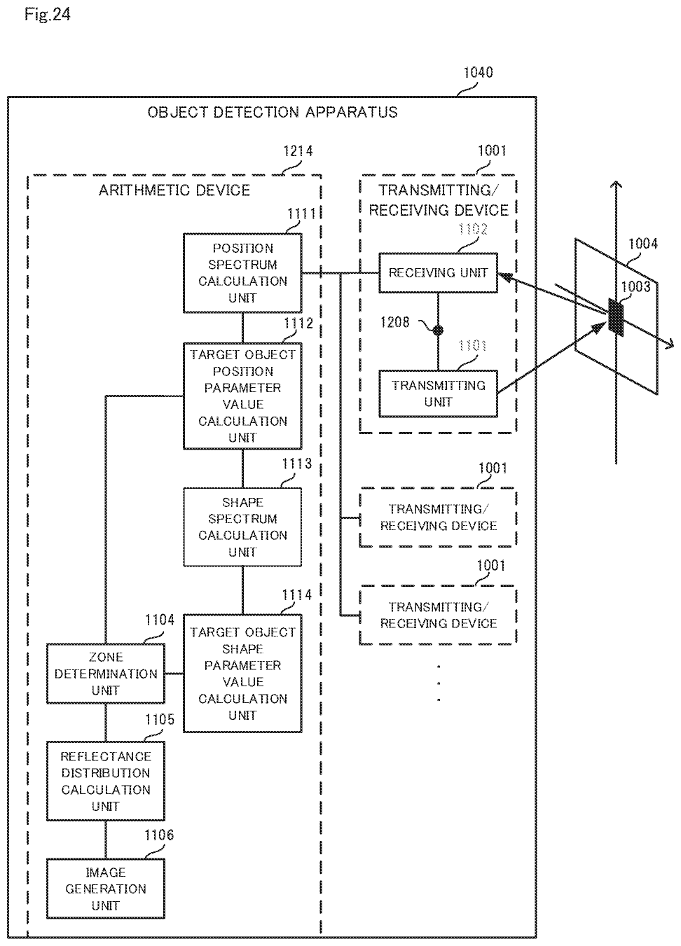

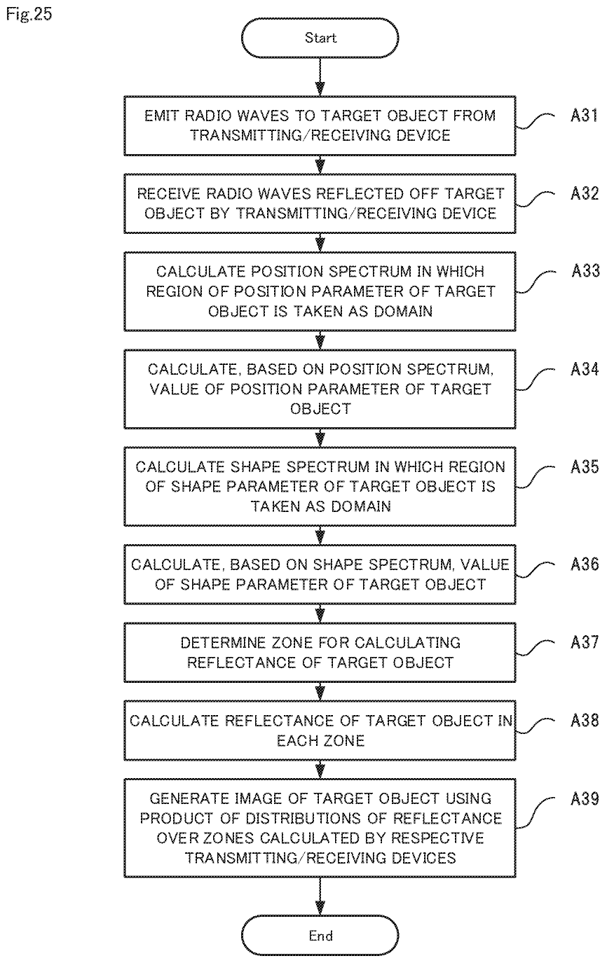

Hereinafter, an object detection apparatus, an object detection method, and a program according to a fourth example embodiment of the invention will be described with reference to FIGS. 24 and 25. Also, in the following, the third example embodiment will be referenced for the description, and descriptions of components common to those of the third example embodiment are omitted.

[Apparatus Configuration]

First, a configuration of the object detection apparatus according to the fourth example embodiment will be described with reference to FIG. 24. FIG. 24 is a block diagram illustrating a configuration of the object detection apparatus according to the fourth example embodiment of the invention.

As shown in FIG. 24, an object detection apparatus 1040 according to the fourth example embodiment is provided with a plurality of transmitting/receiving devices 1001, as with the object detection apparatus 1030 according to the third example embodiment shown in FIG. 23.

On the other hand, as shown in FIG. 24, an arithmetic device 1214 of the object detection apparatus 1040 according to the fourth example embodiment differs from the arithmetic device 1213 shown in FIG. 17. In the fourth example embodiment, the arithmetic device 1214 is provided with, in place of the spectrum calculation unit 1103 and the parameter value calculation unit 1107 shown in FIG. 17, the position spectrum calculation unit 1111, the target object position parameter value calculation unit 1112, the shape spectrum calculation unit 1113, and the target object shape parameter value calculation unit 1114. Furthermore, similar to the arithmetic device 1213 shown in FIG. 17, the arithmetic device 1214 is also provided with the zone determination unit 1104, the reflectance distribution calculation unit 1105, and the image generation unit 1106. The following will mainly describe the differences from the third example embodiment.

The position spectrum calculation unit 1111, the target object position parameter value calculation unit 1112, the shape spectrum calculation unit 1113, and the target object shape parameter value calculation unit 1114 that are used in the fourth example embodiment are the same as those of the second example embodiment shown in FIG. 13. They operate in the same manner as in the second example embodiment.

In other words, the position spectrum calculation unit 1111 calculates, based on IF signals generated by the transmitting/receiving device 1001, a position spectrum in which a region of the position parameter of the target object 1003 is taken as a domain. The target object position parameter value calculation unit 1112 calculates, based on the position spectrum, the value of the position parameter of the target object 1003.

The shape spectrum calculation unit 1113 calculates, based on the IF signals generated by the transmitting/receiving device 1001 and the value of the position parameter of the target object 1003 calculated by the target object position parameter value calculation unit 1112, a shape spectrum in which a region of the shape parameter of the target object 1003 is taken as a domain. The target object shape parameter value calculation unit 1114 calculates, based on the shape spectrum, the value of the shape parameter of the target object 1003.

Note that, also in the third example embodiment, the position spectrum calculation unit 1111, the target object position parameter value calculation unit 1112, the shape spectrum calculation unit 1113, the target object shape parameter value calculation unit 1114, the zone determination unit 1104, the reflectance distribution calculation unit 1105, and the image generation unit 1106 are configured by implementing a later-described program according to the fourth example embodiment into the arithmetic device (computer) 1214.

[Apparatus Operation]

The following will describe an operation of the object detection apparatus 1040 according to the fourth example embodiment of the invention with reference to FIG. 25. FIG. 25 is a flow diagram illustrating an operation of the object detection apparatus according to the fourth example embodiment of the invention. Furthermore, in the fourth example embodiment, an object detection method is executed by operating the object detection apparatus 1040. Accordingly, the description of the object detection method according to the fourth example embodiment is replaced by the following description of the operation of the object detection apparatus 1040.

As shown in FIG. 25, first, the transmitting unit 1101 of each of the transmitting/receiving devices 1001 emits, to the target object 1003, radio waves that serve as transmission signals (step A31). Then, the receiving unit 1102 of the corresponding transmitting/receiving device 1001 receives the radio waves reflected off the target object 1003 as reception signals, and mixes the transmission signals generated by the transmitting unit 1101 with the received reception signals to generate IF signals (step A32). Steps A31 and A32 are the same as steps A1 and A2 shown in FIG. 6.

Then, the position spectrum calculation unit till calculates, based on the IF signals generated in step A32, a position spectrum in which a region of the position parameter of the target object 1003 is taken as a domain (step A33). Then, the target object position parameter value calculation unit 1112 calculates, based on the position spectrum calculated in step A33, the value of the position parameter of the target object 1003 (step A34). Steps A33 and A34 are the same as steps A13 and A14 shown in FIG. 14.

Then, the shape spectrum calculation unit 1113 calculates, based on the IF signals generated in step A32 and the value of the position parameter of the target object 1003 calculated in step A34, a shape spectrum in which a region of the shape parameter of the target object 1003 is taken as a domain (step A35). Then, the target object shape parameter value calculation unit 1114 calculates, based on the shape spectrum calculated in step A35, the value of the shape parameter of the target object 1003 (step A36). Steps A35 and A36 are the same as steps A15 and A16 shown in FIG. 14.

Then, the zone determination unit 1104 determines, based on the value of the position parameter of the target object 1003 calculated in step A34 and the value of the shape parameter calculated in step A36, zones for calculating the reflectance of the object 1003 (step A37). Step A37 is the same as step A25 shown in FIG. 19.

Then, the reflectance distribution calculation unit 1105 calculates, for each pair of transmitting unit 1101 and associated receiving unit 1102, that is, for each transmitting/receiving device 1001, the reflectance of the target object 1003 in each of the zones determined in step A37, based on the IF signals (step A38). Step A38 is the same as step A26 shown in FIG. 19.

Then, the image generation unit 1106 calculates the product of distributions of the reflectance over the zones for the respective pairs, and generates an image of the target object 1003 using the product of distributions of the reflectance calculated for the respective pairs (step A39). The generated image is displayed on a picture plane of an image display device, or the like. Step A39 is the same as step A27 shown in FIG. 19.

As such, also in the fourth example embodiment, an image of the target object 1003 is formed through execution of steps A31 to A39. Also in the fourth example embodiment, it is possible to improve the accuracy of detecting an object using radio waves, while suppressing increases in the device cost, size, and weight.

[Effects of Fourth Example Embodiment]

Also the fourth example embodiment can realize the effects described in the third example embodiment. That is, the fourth example embodiment also realizes a radar method that can not only recognize the position of a target object but also detect information relating to the shape, such as the width, of the target object, while using several small radar devices with a few (to several) antennas.

Furthermore, also in the fourth example embodiment, since an image showing the shape of the target object is formed, it is possible to detect and identify, for example, dangerous goods such as weapons concealed under clothes, in bags, or the like, as well or better than a conventional millimeter-wave imaging device. Furthermore, the fourth example embodiment can also achieve significant reductions in the size, weight, and cost of the device.

Furthermore, also in the fourth example embodiment, since electronic scanning is used instead of mechanical scanning, it is possible to achieve advantageous effects of increasing the scan rate, downsizing the device, extending the lifetime of the device, and improving the maintenance cost, compared to a method using mechanical scanning.

[Program]

A program according to the fourth example embodiment is preferably a program that causes a computer, namely, the arithmetic device 1214 to execute steps A33 to A39 shown in FIG. 25. By installing this program onto the arithmetic device 1214 and executing it, the object detection apparatus and the object detection method according to the fourth example embodiment can be realized. In this case, a Central Processing Unit (CPU) of the arithmetic device 1214 functions as the position spectrum calculation unit 1111, the target object position parameter value calculation unit 1112, the shape spectrum calculation unit 1113, the target object shape parameter value calculation unit 1114, the zone determination unit 1104, the reflectance distribution calculation unit 1105, and the image generation unit 1106, and performs processing.

Furthermore, the program according to the fourth example embodiment may also be executed by a computer system constituted by a plurality of computers. In this case, for example, each of the computers may also function as any one of the position spectrum calculation unit 1111, the target object position parameter value calculation unit 1112, the shape spectrum calculation unit 1113, the target object shape parameter value calculation unit 1114, the zone determination unit 1104, the reflectance distribution calculation unit 1105, and the image generation unit 1106.

(Physical Configuration)

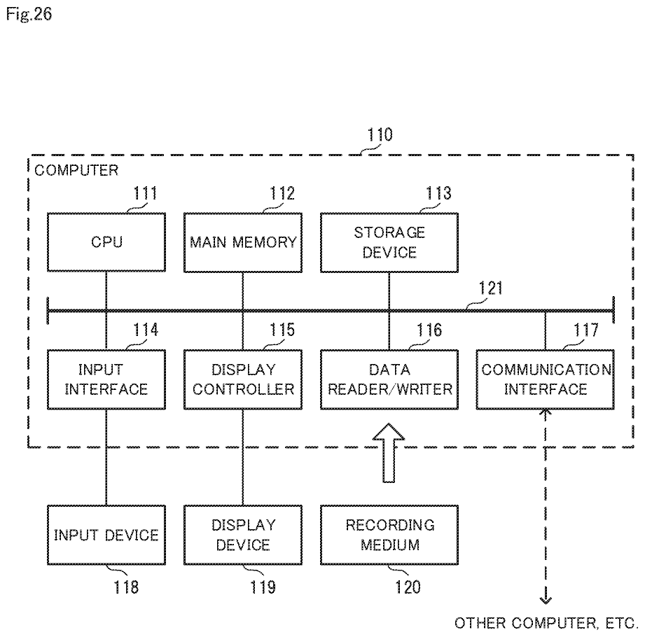

The following will describe the computers (arithmetic devices) that execute the programs according to the first to fourth example embodiments to realize the object detection apparatuses, with reference to FIG. 26. FIG. 26 is a block diagram illustrating an example of such computers that realize the object detection apparatuses according to the example embodiments of the invention.

As shown in FIG. 26, a computer 110 is provided with a CPU 111, a main memory 112, a storage device 113, an input interface 114, a display controller 115, a data reader/writer 116, and a communication interface 117. These components are connected to each other via a bus 121 so as to be able to communicate data with each other. Note that the computer 110 may also be provided with, in addition to or in place of the CPU 111, a Graphics Processing Unit (GPU) or a Field-Programmable Gate Array (FPGA).

The CPU 111 expands the programs (codes) according to the example embodiments stored in the storage device 113 onto the main memory 112, and executes them in a predetermined order, thereby executing various types of calculation. The main memory 112 is typically a volatile storage device such as a Dynamic Random Access Memory (DRAM). Furthermore, the programs according to the example embodiments are provided in a state of being stored in the computer-readable recording medium 120. Note that the programs according to the example embodiments may also be distributed on the Internet connected via the communication interface 117.

Furthermore, specific examples of the storage device 113 include, besides a hard disk drive, a semiconductor storage device such as a flash memory. The input interface 114 intermediates data transmission between the CPU 111 and an input device 118 such as a keyboard or a mouse. The display controller 115 is connected to a display device 119, and controls display on the display device 119.

The data reader/writer 116 intermediates data transmission between the CPU 111 and the recording medium 120, and executes reading of a program from the recording medium 120, and writing of a result of processing by the computer 110 to the recording medium 120. The communication interface 117 intermediates data transmission between the CPU 111 and another computer.

Furthermore, specific examples of the recording medium 120 include a general-purpose semiconductor storage device such as a Compact Flash (registered trademark) (CF) and a Secure Digital (SD), a magnetic recording medium such as a flexible disk, or and optical recording medium such as a Compact Disk Read Only Memory (CD-ROM).

Note that the object detection apparatus 1000 according to the example embodiment may also be realized by, instead of a computer in which a program is installed, hardware that corresponds to the constituent components. Furthermore, a configuration may also be employed in which part of the object detection apparatus 1000 is realized by a program, and the remaining part thereof is realized by hardware.

Although the invention of the present application has been described with reference to the embodiments above, the invention of the present application is not limited to the above example embodiments. Furthermore, the content disclosed in the above-described Patent Documents and the like may also be incorporated in the invention of the present application by reference. In the frame of the entire disclosure (including the claims) of the invention of the present application, and further on the basis of its basic technical concept, modification and adjustment of the example embodiments are possible. Furthermore, in the frame of the claims of the invention of the present application, various combinations or selection of various disclosed elements is also possible. In other words, the invention of the present application, of course, encompasses various modifications and corrections understandable to a person skilled in the art, according to the entire disclosure including the claims and the technical idea.

Parts or whole of the above-described example embodiments can be expressed in the below-described Supplementary notes 1 to 18, but the present invention is not limited to the below description.

(Supplementary Note 1)

An object detection apparatus for detecting an object using radio waves, including:

a transmitting unit for emitting, to the object, radio waves that serve as transmission signals;

a receiving unit for receiving the radio waves reflected off the object as reception signals;

a spectrum calculating unit for calculating, based on the transmission signals and the reception signals, a spectrum in which a region of a position parameter of the object and a region of a shape parameter of the object are taken as domains; and

a parameter value calculating unit for calculating, based on the spectrum calculated by the spectrum calculating unit, a value of the position parameter of the object and a value of the shape parameter of the object.

(Supplementary Note 2)

The object detection apparatus according to Supplementary note 1,

wherein a plurality of the transmitting units and a plurality of the receiving units are provided,

the plurality of receiving units are respectively associated with the plurality of transmitting units,

the spectrum calculating unit calculates, for each pair of transmitting unit and associated receiving unit, a spectrum in which a region of a position parameter of the object and a region of a shape parameter of the object are taken as domains based on the transmission signals and the reception signals,

the parameter value calculating unit calculates, based on the spectrum calculated for each pair by the spectrum calculating unit, a value of the position parameter of the object and a value of the shape parameter of the object, and

the object detection apparatus further includes:
a zone determining unit for determining, based on the values of the position parameter and the shape parameter of the object calculated by the parameter value calculating unit, zones for calculating reflectance of the object;
a reflectance distribution calculating unit for calculating, for each pair, reflectance of the object in each of the zones determined by the zone determinations unit, based on the transmission signals and the reception signals; and
an image generating unit for obtaining a product of distributions of the reflectance calculated for the respective pairs, and generating, using the obtained product, an image of the object.

(Supplementary Note 3)

The object detection apparatus according to Supplementary note 1 or 2,

wherein the transmitting unit transmits, as the transmission signals, radio waves whose frequency is modulated.

(Supplementary Note 4)

The object detection apparatus according to any one of Supplementary notes 1 to 3,

wherein a plurality of the transmitting units are provided, and the plurality of transmitting units respectively emit the transmission signals at different timings, or emit the transmission signals in different transmission frequencies.

(Supplementary Note 5)

The object detection apparatus according to any one of Supplementary notes 1 to 4,

wherein the receiving unit receives radio waves reflected off the object as the reception signals, and further mixes the transmission signals with the received reception signals to generate intermediate frequency signals, and

the spectrum calculating unit calculates the spectrum based on the intermediate frequency signals.

(Supplementary Note 6)

The object detection apparatus according to Supplementary note 5,

wherein the spectrum calculating unit calculates, based on measured values of the intermediate frequency signals for which different sampling time ranges are preset, correlation matrices that correspond to the respective sampling time ranges, and

the spectrum calculating unit further calculates an average of the correlation matrices that correspond to the respective sampling time ranges, and then calculates the spectrum based on the average of the correlation matrices.

(Supplementary Note 7)

An object detection method for detecting an object using a device that includes a transmitting unit for emitting, to the object, radio waves that serve as transmission signals, and a receiving unit for receiving the radio waves reflected off the object as reception signals, the method including:

(a) a step of calculating, based on the transmission signals and the reception signals, a spectrum in which a region of a position parameter of the object and a region of a shape parameter of the object are taken as domains; and

(b) a step of calculating, based on the spectrum calculated in the (a) step, a value of the position parameter of the object and a value of the shape parameter of the object.

(Supplementary Note 8)

The object detection method according to Supplementary note 7,

wherein the device includes a plurality of the transmitting units and a plurality of the receiving units, the plurality of receiving units being respectively associated with the plurality of transmitting units,

in the (a) step, for each pair of transmitting unit and associated receiving unit, a spectrum in which a region of a position parameter of the object and a region of a shape parameter of the object are taken as domains is calculated based on the transmission signals and the reception signals,

in the (b) step, based on the spectrum calculated for each pair in the (a) step, a value of the position parameter of the object and a value of the shape parameter of the object are calculated, and

the object detection method further includes:
(c) a step of determining, based on the value of the position parameter of the object and the value of the shape parameter of the object calculated in the (b) step, zones for calculating reflectance of the object;
(d) a step of calculating, for each pair, reflectance of the object in each of the zones determined in the (c) step, based on the transmission signals and the reception signals; and
(e) a step of obtaining a product of distributions of the reflectance calculated for the respective pairs, and generating, using the obtained product, an image of the object.

(Supplementary Note 9)

The object detection method according to Supplementary note 7 or 8,

wherein the transmitting unit transmits, as the transmission signals, radio waves whose frequency is modulated.

(Supplementary Note 10)

The object detection method according to any one of Supplementary notes 7 to 9,

wherein a plurality of the transmitting units are provided, and

the plurality of transmitting units respectively emit the transmission signals at different timings, or emit the transmission signals in different transmission frequencies.

(Supplementary Note 11)

The object detection method according to any one of Supplementary notes 7 to 10,

wherein the receiving unit receives radio waves reflected off the object as the reception signals, and further mixes the transmission signals with the received reception signals to generate intermediate frequency signals, and

in the (a) step, the spectrum is calculated based on the intermediate frequency signals.

(Supplementary Note 12)

The object detection method according to Supplementary note 11,

wherein, in the (a) step, correlation matrices that correspond to the respective sampling time ranges are calculated based on measured values of the intermediate frequency signals for which different sampling time ranges are preset, an average of the correlation matrices that correspond to the respective sampling time ranges is further calculated, and then the spectrum is calculated based on the average of the correlation matrices.

(Supplementary Note 13)

A computer readable recording medium for use in an object detection apparatus that includes a transmitting unit for emitting, to an object, radio waves that serve as transmission signals, a receiving unit for receiving the radio waves reflected off the object as reception signals, and a processor, the computer readable recording medium including a program recorded thereon, the program including instructions that cause the processor to carry out:

(a) a step of calculating, based on the transmission signals and the reception signals, a spectrum in which a region of a position parameter of the object and a region of a shape parameter of the object are taken as domains; and

(b) a step of calculating, based on the spectrum calculated in the (a) step, a value of the position parameter of the object and a value of the shape parameter of the object.

(Supplementary Note 14)

The computer readable recording medium according to Supplementary note 13,

wherein the device includes a plurality of the transmitting units and a plurality of the receiving units, the plurality of receiving units being respectively associated with the plurality of transmitting units,

in the (a) step, for each pair of transmitting unit and associated receiving unit, a spectrum in which a region of a position parameter of the object and a region of a shape parameter of the object are taken as domains is calculated based on the transmission signals and the reception signals,

in the (b) step, based on the spectrum calculated for each pair in the (a) step, a value of the position parameter of the object and a value of the shape parameter of the object are calculated, and

the program further including instructions that cause the processor to carry out:
(c) a step of determining, based on the value of the position parameter of the object and the value of the shape parameter of the object calculated in the (b) step, zones for calculating reflectance of the object;
(d) a step of calculating, for each pair, reflectance of the object in each of the zones determined in the (c) step, based on the transmission signals and the reception signals; and
(e) a step of obtaining a product of distributions of the reflectance calculated for the respective pairs, and generating, using the obtained product, an image of the object.

(Supplementary Note 15)

The computer readable recording medium according to Supplementary note 13 or 14,

wherein the transmitting unit transmits, as the transmission signals, radio waves whose frequency is modulated.

(Supplementary Note 16)

The computer readable recording medium according to any one of Supplementary notes 13 to 15,

wherein a plurality of the transmitting units are provided, and

the plurality of transmitting units respectively emit the transmission signals at different timings, or emit the transmission signals in different transmission frequencies.

(Supplementary Note 17)

The computer readable recording medium according to any one of Supplementary notes 13 to 16,

wherein the receiving unit receives radio waves reflected off the object as the reception signals, and further mixes the transmission signals with the received reception signals to generate intermediate frequency signals, and

in the (a) step, the spectrum is calculated based on the intermediate frequency signals.

(Supplementary Note 18)

The computer readable recording medium according to Supplementary note 17,

wherein, in the (a) step, correlation matrices that correspond to the respective sampling time ranges are calculated based on measured values of the intermediate frequency signals for which different sampling time ranges are preset, an average of the correlation matrices that correspond to the respective sampling time ranges is further calculated, and then the spectrum is calculated based on the average of the correlation matrices.

The present application is based upon and claims the benefit of priority from Japanese application No. 2017-131542, filed on Jul. 4, 2017, the disclosure of which is incorporated herein in its entirety by reference.

### INDUSTRIAL APPLICABILITY

As described above, according to the invention, it is possible to improve the accuracy of detecting an object using radio waves, while suppressing increases in the device cost, size, and weight. The invention is useful when used as a radar device that functions to calculate parameters relating to the position and the shape of a target object, measure the position of the target object, and identify the type of the target object based on the shape parameter of the target object, or an imaging device that images items behind clothes, items in bags, or the like, and inspect them.

### LIST OF REFERENCE SIGNS

110 Computer
111 CPU
112 Main memory
113 Storage device
114 Input interface
115 Display controller
116 Data reader/writer
117 Communication interface
118 Input device
119 Display device
120 Recording medium
121 Bus
1000 Object detection apparatus
1001 Transmitting/receiving device
1002 Transmitting/receiving device arranged plane
1003 Target object (object to be detected)
1004 Target object arranged plane
1101 Transmitting unit
1102 Receiving unit
1103 Spectrum calculation unit
1104 Zone determination unit
1105 Reflectance distribution calculation unit
1106 Image generation unit
1107 Parameter value calculation unit
1108 Calculation result output unit
1111 Position spectrum calculation unit
1112 Target object position parameter value calculation unit
1113 Shape spectrum calculation unit
1114 Target object shape parameter value calculation unit
1201 Oscillator
1202 Transmitting antenna
1203 Receiving antenna
1204 Mixer
1205 Interface circuit
1206, 1207 Variable phase shifter
1208 Terminal
1211 Arithmetic device
1221 Sub array
1231 RF frequency

What is claimed is:

1. An object detection apparatus for detecting an object using radio waves, comprising:
a transmitting unit configured to emit, to the object, radio waves that serve as transmission signals;
a receiving unit configured to receive the radio waves reflected off the object as reception signals;
a spectrum calculation unit configured to calculate, based on the transmission signals and the reception signals, a spectrum in which a region of a position parameter of the object and a region of a shape parameter of the object are taken as domains; and
a parameter value calculation unit configured to calculate, based on the spectrum calculated by the spectrum calculating means, a value of the position parameter of the object and a value of the shape parameter of the object.

2. The object detection apparatus according to claim 1,
wherein a plurality of the transmitting units and a plurality of the receiving units are provided,
the plurality of receiving units are respectively associated with the plurality of transmitting units,
the spectrum calculation unit calculates, for each pair of transmitting unit and associated receiving unit, a spectrum in which a region of a position parameter of the object and a region of a shape parameter of the object are taken as domains based on the transmission signals and the reception signals,
the parameter value calculation unit calculates, based on the spectrum calculated for each pair by the spectrum calculation unit, a value of the position parameter of the object and a value of the shape parameter of the object, and
the object detection apparatus further comprises:
a zone determination unit configured to determine, based on the values of the position parameter and the shape parameter of the object calculated by the parameter value calculation unit, zones for calculating reflectance of the object;
a reflectance distribution calculation unit configured to calculate, for each pair, reflectance of the object in each of the zones determined by the zone determination unit, based on the transmission signals and the reception signals; and
an image generation unit configured to obtain a product of distributions of the reflectance calculated for the respective pairs, and generating, using the obtained product, an image of the object.

3. The object detection apparatus according to claim 1,
wherein the transmitting unit transmits, as the transmission signals, radio waves whose frequency is modulated.

4. The object detection apparatus according to claim 1,
wherein a plurality of the transmitting units are provided, and
the plurality of transmitting unit respectively emit the transmission signals at different timings, or emit the transmission signals in different transmission frequencies.

5. The object detection apparatus according to claim 1,
wherein the receiving unit receives radio waves reflected off the object as the reception signals, and further mixes the transmission signals with the received reception signals to generate intermediate frequency signals, and
the spectrum calculation unit calculates the spectrum based on the intermediate frequency signals.

6. The object detection apparatus according to claim 5,
wherein the spectrum calculation unit calculates, based on measured values of the intermediate frequency signals for which different sampling time ranges are preset, correlation matrices that correspond to the respective sampling time ranges, and
the spectrum calculation unit further calculates an average of the correlation matrices that correspond to the respective sampling time ranges, and then calculates the spectrum based on the average of the correlation matrices.

7. An object detection method for detecting an object using a device that includes a transmitting unit configured to emit, to the object, radio waves that serve as transmission signals, and a receiving unit configured to receive the radio waves reflected off the object as reception signals, the method comprising:
(a) calculating, based on the transmission signals and the reception signals, a spectrum in which a region of a position parameter of the object and a region of a shape parameter of the object are taken as domains; and
(b) calculating, based on the spectrum calculated in the (a), a value of the position parameter of the object and a value of the shape parameter of the object.

8. A non-transitory computer readable recording medium for use in an object detection apparatus that includes a transmitting unit for emitting, to an object, radio waves that serve as transmission signals, a receiving unit for receiving the radio waves reflected off the object as reception signals, and a processor, the computer readable recording medium including a program recorded thereon, the program including instructions that cause the processor to carry out:
(a) a step of calculating, based on the transmission signals and the reception signals, a spectrum in which a region of a position parameter of the object and a region of a shape parameter of the object are taken as domains; and
(b) a step of calculating, based on the spectrum calculated in the (a) step, a value of the position parameter of the object and a value of the shape parameter of the object.

9. The object detection method according to claim 7,
wherein the device includes a plurality of the transmitting units and a plurality of the receiving units, the plurality of receiving units being respectively associated with the plurality of transmitting units,
in the (a), for each pair of transmitting unit and associated receiving unit, a spectrum in which a region of a position parameter of the object and a region of a shape parameter of the object are taken as domains is calculated based on the transmission signals and the reception signals,
in the (b), based on the spectrum calculated for each pair in the (a), a value of the position parameter of the object and a value of the shape parameter of the object are calculated, and
the object detection method further includes:
(c) determining, based on the value of the position parameter of the object and the value of the shape parameter of the object calculated in the (b), zones for calculating reflectance of the object;
(d) calculating, for each pair, reflectance of the object in each of the zones determined in the (c), based on the transmission signals and the reception signals; and
(e) obtaining a product of distributions of the reflectance calculated for the respective pairs, and generating, using the obtained product, an image of the object.

10. The object detection method according to claim 7,
wherein the transmitting unit transmits, as the transmission signals, radio waves whose frequency is modulated.

11. The object detection method according to claim 7,
wherein a plurality of the transmitting units are provided, and
the plurality of transmitting units respectively emit the transmission signals at different timings, or emit the transmission signals in different transmission frequencies.

12. The object detection method according to claim 7,
wherein the receiving unit receives radio waves reflected off the object as the reception signals, and further mixes the transmission signals with the received reception signals to generate intermediate frequency signals, and
in the (a), the spectrum is calculated based on the intermediate frequency signals.

13. The object detection method according to claim 12,
wherein, in the (a), correlation matrices that correspond to the respective sampling time ranges are calculated based on measured values of the intermediate frequency signals for which different sampling time ranges are preset, an average of the correlation matrices that correspond to the respective sampling time ranges is further calculated, and then the spectrum is calculated based on the average of the correlation matrices.

14. The non-transitory computer readable recording medium according to claim 8,
wherein the device includes a plurality of the transmitting units and a plurality of the receiving units, the plurality of receiving units being respectively associated with the plurality of transmitting units,
in the (a) step, for each pair of transmitting unit and associated receiving unit, a spectrum in which a region of a position parameter of the object and a region of a shape parameter of the object are taken as domains is calculated based on the transmission signals and the reception signals,
in the (b) step, based on the spectrum calculated for each pair in the (a) step, a value of the position parameter of the object and a value of the shape parameter of the object are calculated, and
the program further including instructions that cause the processor to carry out:
(c) a step of determining, based on the value of the position parameter of the object and the value of the shape parameter of the object calculated in the (b) step, zones for calculating reflectance of the object;
(d) a step of calculating, for each pair, reflectance of the object in each of the zones determined in the (c) step, based on the transmission signals and the reception signals; and
(e) a step of obtaining a product of distributions of the reflectance calculated for the respective pairs, and generating, using the obtained product, an image of the object.

15. The non-transitory computer readable recording medium according to claim 8,
wherein the transmitting unit transmits, as the transmission signals, radio waves whose frequency is modulated.

16. The non-transitory computer readable recording medium according to claim 8,
wherein a plurality of the transmitting units are provided, and
the plurality of transmitting units respectively emit the transmission signals at different timings, or emit the transmission signals in different transmission frequencies.

17. The non-transitory computer readable recording medium according to claim 8,
wherein the receiving unit receives radio waves reflected off the object as the reception signals, and further mixes the transmission signals with the received reception signals to generate intermediate frequency signals, and
in the (a) step, the spectrum is calculated based on the intermediate frequency signals.

18. The non-transitory computer readable recording medium according to claim 17,
wherein, in the (a) step, correlation matrices that correspond to the respective sampling time ranges are calculated based on measured values of the intermediate frequency signals for which different sampling time ranges are preset, an average of the correlation matrices that correspond to the respective sampling time ranges is further calculated, and then the spectrum is calculated based on the average of the correlation matrices.
